(19) United States
(12) Patent Application Publication
(10) Pub. No.: US 2021/0002148 A1
(43) Pub. Date: Jan. 7, 2021

(54) WATER TREATMENT APPARATUS, WATER TREATMENT METHOD, AND METHOD OF STARTING WATER TREATMENT APPARATUS

(71) Applicant: JFE Engineering Corporation, Tokyo (JP)

(72) Inventors: Yuya SATO, Tokyo (JP); Takeshi TSUJI, Tokyo (JP); Koji FUCHIGAMI, Tokyo (JP); Keiji TOMURA, Tokyo (JP); Shigeki FUJIWARA, Tokyo (JP); Makoto KUNUGI, Tokyo (JP); Eri WATANABE, Tokyo (JP); Aya OSATO, Tokyo (JP)

(21) Appl. No.: 16/968,814

(22) PCT Filed: Feb. 20, 2019
(86) PCT No.: PCT/JP2019/006214

§ 371 Date: Aug. 10, 2020

(30) Foreign Application Priority Data
Feb. 26, 2018 (JP) 2018-032166
Mar. 27, 2018 (JP) 2018-059291

(51) Int. Cl. C02F 1/44; B01D 61/00; C02F 103/08

(52) U.S. Cl. CPC C02F 1/445; B01D 61/005; B01D 2311/2626; C02F 2103/08; B01D 2311/103; B01D 2313/38; B01D 2311/25; B01D 2311/106

(57) ABSTRACT

A water treatment apparatus including: a forward osmosis device configured to allow a diluted draw solution to flow out and to discharge a water-containing solution; a heater configured to heat the diluted draw solution; a water separator configured to separate the diluted draw solution heated by the heater into a water-rich solution and the draw solution having water content lower than that of the water-rich solution; a cooler configured to cool a liquid and allow the liquid to flow out as a coolant; an inflow side heat exchanger configured to perform heat exchange between the coolant flowed out from the cooler and the draw solution flowed out from the water separator; and an outflow side heat exchanger configured to perform heat exchange between the diluted draw solution flowed out from the forward osmosis device and the water-rich solution flowed out from the water separator.

### TECHNICAL FIELD

The present disclosure relates to a water treatment apparatus, water treatment method, and a method of starting the water treatment apparatus for extracting water from a water-containing solution containing water as a solvent.

### BACKGROUND ART

There are known a water treatment system and a water treatment apparatus that use seawater, river water, industrial effluent, or the like as water to be treated (feed solution), use a liquid having an osmotic pressure higher than that of the water to be treated as an induction solution (draw solution), and bring the draw solution into contact with the water to be treated via a semipermeable membrane to cause fresh water to permeate the draw solution from the water to be treated.

In a case of using a temperature sensitive substance as the draw solution in the water treatment system, a diluted draw solution that is diluted by moved fresh water is heated, and the fresh water is separated from the diluted draw solution through phase separation by heating. The draw solution from which the fresh water is separated and extracted is cooled and reused as a recycled draw solution to be brought into contact with the water to be treated. For example, Japanese Patent Application Laid-open No. 2017-18952 discloses a water treatment apparatus that performs heat exchange between respective low-temperature diluted draw solutions diverged into two flow passages, and a high-temperature recycled draw solution and the fresh water.

### CITATION LIST

### Patent Literature

### [PTL 1]

### Japanese Patent Application Laid-open No. 2017-18952

### SUMMARY OF INVENTION

### Technical Problem

However, the water treatment apparatus in the related art described above does not include a cooling mechanism, so that the recycled draw solution that has reached a high temperature is not sufficiently cooled. Thus, there has been developed a method of cooling the recycled draw solution that has reached a high temperature by using a water-containing solution that is separately taken in. However, in this case, the water-containing solution needs to be newly taken in, so that energy required for the water treatment apparatus is increased and running costs are increased. Thus, there has been a demand for a technique of suppressing energy consumption required for cooling and heating, and stabilizing balance of energy in the water treatment apparatus.

The present invention is made in view of such a situation, and provides a water treatment apparatus and a water treatment method for stabilizing balance of energy in a process by suppressing energy consumption required for cooling and heating without taking in a water-containing solution for cooling.

The present invention also provides a method of starting the water treatment apparatus for shortening a starting time until reaching a steady state while stably starting the water treatment apparatus that causes fresh water to permeate the draw solution from the water-containing solution.

### Solution to Problem

In order to solve the above described problem and achieve the object, a water treatment apparatus according to one aspect of the present disclosure includes: a forward osmosis unit configured to allow a diluted draw solution to flow out, the diluted draw solution being obtained by causing water to move to a draw solution having a cloud point from a water-containing solution containing water as a solvent via a semipermeable membrane to dilute the draw solution, and configured to discharge the water-containing solution as a concentrated water-containing solution that is concentrated; a heating unit configured to heat the diluted draw solution to a temperature equal to or higher than the cloud point; a water separation unit configured to separate the diluted draw solution heated by the heating unit into a water-rich solution and the draw solution having water content lower than that of the water-rich solution; a cooling unit configured to cool a liquid and allow the liquid to flow out as a coolant; an inflow side heat exchange unit configured to perform heat exchange between the coolant flowed out from the cooling unit and the draw solution flowed out from the water separation unit; and an outflow side heat exchange unit configured to perform heat exchange between the diluted draw solution flowed out from the forward osmosis unit and the water-rich solution flowed out from the water separation unit.

In the above disclosure the water treatment apparatus according to one aspect of the present disclosure, further comprises a separation treatment unit configured to obtain generated water from the water-rich solution. The water treatment apparatus according to the construction further comprises a heat exchange unit before final treatment disposed on a downstream side of the outflow side heat exchange unit and an upstream side of the separation treatment unit along a flowing direction of the water-rich solution, the heat exchange unit before final treatment configured to perform heat exchange between the water-rich solution flowed out from the water separation unit and the coolant flowed out from the cooling unit. The water treatment apparatus according to the construction, wherein the separation treatment unit is configured to supply, to the cooling unit, separation treatment effluent separated from the generated water.

In the above disclosure the water treatment apparatus according to one aspect of the present disclosure, further comprises a succeeding stage heat exchange unit configured to perform heat exchange between the draw solution flowed out from the water separation unit and the diluted draw solution flowed out from the forward osmosis unit.

In the above disclosure the water treatment apparatus according to one aspect of the present disclosure, further comprises a preceding stage heat exchange unit disposed on an upstream side of the outflow side heat exchange unit along a flowing direction of the diluted draw solution, the preceding stage heat exchange unit configured to perform heat exchange between the draw solution flowed out from the water separation unit and the diluted draw solution flowed out from the forward osmosis unit.

In the above disclosure the water treatment apparatus according to one aspect of the present disclosure, is configured to circulate the coolant between the cooling unit and the inflow side heat exchange unit.

In the above disclosure the water treatment apparatus according to one aspect of the present disclosure, is configured to cause the diluted draw solution flowed out from the forward osmosis unit to diverge to be heat-exchanged by a parallel heat exchange unit in which at least two heat exchangers are arranged in parallel, and configured to cause diverged diluted draw solutions heat-exchanged by the parallel heat exchange unit to converge on an upstream side of the heating unit. The water treatment apparatus according to the construction, wherein the parallel heat exchange unit is configured such that one of the diverged diluted draw solutions is heat-exchanged with the water-rich solution flowed out from the water separation unit, and the other one of the diverged diluted draw solutions is heat-exchanged with the draw solution flowed out from the water separation unit.

In the above disclosure the water treatment apparatus according to one aspect of the present disclosure, further comprises a circulation flow passage configured to cause a downstream side of the water separation unit and an upstream side of the forward osmosis unit along a flowing direction of the draw solution to communicate with an upstream side of the heating unit and a downstream side of the forward osmosis unit along a flowing direction of the diluted draw solution.

In the above disclosure the water treatment apparatus according to one aspect of the present disclosure, further comprises a diluted draw storage unit configured to store the diluted draw solution flowed out from the forward osmosis unit, and an upstream side bypass flow passage configured to cause the diluted draw storage unit to communicate with a downstream side of the water separation unit and an upstream side of the forward osmosis unit along a flowing direction of the draw solution.

In the above disclosure the water treatment apparatus according to one aspect of the present disclosure, further comprising a diluted draw storage unit configured to store the diluted draw solution flowed out from the forward osmosis unit, and a downstream side bypass flow passage configured to cause the diluted draw storage unit to communicate with a downstream side of the water separation unit along a flowing direction of the water-rich solution.

A water treatment method according to one aspect of the present disclosure includes: a forward osmosis process of allowing a diluted draw solution to flow out, the diluted draw solution being obtained by causing water to move to a draw solution having a cloud point from a water-containing solution containing water as a solvent via a semipermeable membrane to dilute the draw solution, and discharging the water-containing solution as a concentrated water-containing solution that is concentrated; a heating process of heating the diluted draw solution to a temperature equal to or higher than the cloud point; a water separation process of separating the diluted draw solution heated in the heating process into a water-rich solution and the draw solution having water content lower than that of the water-rich solution; a coolant generation process of cooling a liquid to generate a coolant; an inflow side heat exchange process of performing heat exchange between the coolant obtained in the coolant generation process and the draw solution obtained in the water separation process; and an outflow side heat exchange process of performing heat exchange between the diluted draw solution obtained in the forward osmosis process and the water-rich solution obtained in the water separation process.

In the above disclosure the water treatment method according to one aspect of the present disclosure, further comprises a separation treatment process of obtaining generated water from the water-rich solution. The water treatment method according to the construction, further comprises, before the separation treatment process, a heat exchange process before final treatment of performing heat exchange between the water-rich solution obtained in the water separation process and the coolant obtained in the coolant generation process. The water treatment method according to the construction, wherein separation treatment effluent separated from the generated water through the separation treatment process is used for the coolant generation process.

In the above disclosure the water treatment method according to one aspect of the present disclosure, further comprises, before the outflow side heat exchange process, a preceding stage heat exchange process of performing heat exchange between the diluted draw solution obtained in the forward osmosis process and the draw solution obtained in the water separation process.

In the above disclosure the water treatment method according to one aspect of the present disclosure, further comprises a succeeding stage heat exchange process of performing heat exchange between the draw solution obtained in the water separation process and the diluted draw solution that is heat-exchanged in the outflow side heat exchange process.

In the above disclosure the water treatment method according to one aspect of the present disclosure, wherein the coolant after being heat-exchanged in the inflow side heat exchange process is cooled in the coolant generation process.

In the above disclosure the water treatment method according to one aspect of the present disclosure, further comprising a parallel heat exchange process of causing the diluted draw solution obtained in the forward osmosis process to diverge, and performing heat exchange between diverged diluted draw solutions by at least two heat exchangers in parallel, wherein the diverged diluted draw solutions are caused to converge after the parallel heat exchange process and before the heating process. The water treatment method according to the construction, wherein, in the parallel heat exchange process, one of the diverged diluted draw solutions is heat-exchanged with the water-rich solution obtained in the water separation process, and the other one of the diverged diluted draw solutions is heat-exchanged with the draw solution obtained in the water separation process.

A method of starting a water treatment apparatus according to one aspect of the present disclosure, the water treatment apparatus including: a forward osmosis unit configured to allow a diluted draw solution to flow out, the diluted draw solution being obtained by causing water to move to a draw solution having a cloud point from a water-containing solution containing water as a solvent via a semipermeable membrane to dilute the draw solution, and configured to discharge the water-containing solution as a concentrated water-containing solution that is concentrated; a heating unit configured to heat the diluted draw solution to a temperature equal to or higher than the cloud point; a water separation unit configured to separate the diluted draw solution heated by the heating unit into a water-rich solution and the draw solution having water content lower than that of the water-rich solution; a cooling unit configured to cool a liquid and allow the liquid to flow out as a coolant; an inflow side heat exchange unit configured to perform heat exchange between the coolant flowed out from the cooling unit and the draw solution flowed out from the water separation unit; and an outflow side heat exchange unit configured to perform heat exchange between the diluted draw solution flowed out from the forward osmosis unit and the water-rich solution flowed out from the water separation unit, the method including: a separation and circulation process of supplying the draw solution stored in the water separation unit to the heating unit to be heated to a temperature equal to or higher than the cloud point through a circulation flow passage that causes a downstream side of the water separation unit and an upstream side of the forward osmosis unit along a flowing direction of the draw solution to communicate with an upstream side of the heating unit and a downstream side of the forward osmosis unit along a flowing direction of the diluted draw solution.

In the above disclosure the method of starting the water treatment apparatus according to one aspect of the present disclosure, wherein the water treatment apparatus further comprises a diluted draw storage unit configured to store the diluted draw solution flowed out from the forward osmosis unit, and an upstream side bypass flow passage configured to cause the diluted draw storage unit to communicate with a downstream side of the water separation unit and an upstream side of the forward osmosis unit along a flowing direction of the draw solution, and the method further comprises, after the separation and circulation process, an upstream side bypass process of supplying the draw solution stored in the water separation unit to the diluted draw storage unit through the upstream side bypass flow passage.

In the above disclosure the method of starting the water treatment apparatus according to one aspect of the present disclosure, wherein the water treatment apparatus further comprises a diluted draw storage unit configured to store the diluted draw solution flowed out from the forward osmosis unit, and a downstream side bypass flow passage configured to cause the diluted draw storage unit to communicate with a downstream side of the water separation unit along a flowing direction of the water-rich solution, and the method further comprises, after the separation and circulation process, a downstream side bypass process of supplying the water-rich solution flowed out from the water separation unit to the diluted draw storage unit through the downstream side bypass flow passage.

In the above disclosure the method of starting the water treatment apparatus according to one aspect of the present disclosure, further comprising an outflow side temperature raising process of performing heat exchange between the draw solution flowed out from the diluted draw storage unit and the water-rich solution flowed out from the water separation unit by the outflow side heat exchange unit to raise a temperature of the draw solution flowed out from the diluted draw storage unit. The method of starting the water treatment apparatus according to the construction, further comprises, after the outflow side temperature raising process, a heating process of heating the draw solution flowed out from the diluted draw storage unit by the heating unit.

In the above disclosure the method of starting the water treatment apparatus according to one aspect of the present disclosure, wherein the water treatment apparatus further comprises a succeeding stage heat exchange unit configured to perform heat exchange between the diluted draw solution flowed out from the diluted draw storage unit and the draw solution flowed out from the water separation unit, and the method further comprises a succeeding stage temperature raising process of performing heat exchange between the draw solution flowed out from the diluted draw storage unit and the draw solution flowed out from the water separation unit by the succeeding stage heat exchange unit to raise a temperature of the draw solution flowed out from the diluted draw storage unit.

In the above disclosure the method of starting the water treatment apparatus according to one aspect of the present disclosure, wherein the water treatment apparatus is configured to cause the diluted draw solution flowed out from the diluted draw storage unit to diverge to be heat-exchanged by a parallel heat exchange unit in which at least two heat exchange units are arranged in parallel, and configured to cause diverged diluted draw solutions heat-exchanged by the parallel heat exchange unit to converge on an upstream side of the heating unit, and the method further comprises a parallel heat exchange process of performing heat exchange between the draw solution flowed out from the diluted draw storage unit and the water-rich solution flowed out from the water separation unit by one of the at least two heat exchange units, and performing heat exchange between the draw solution flowed out from the diluted draw storage unit and the draw solution flowed out from the water separation unit by the other one of the at least two heat exchange units. The method of starting the water treatment apparatus according to the construction, further comprises, after the parallel heat exchange process, a heating process of heating, by the heating unit, converged draw solution flowed out from the diluted draw storage unit.

### Advantageous Effects of Invention

With the water treatment apparatus and the water treatment method according to the present disclosure, balance of energy can be stabilized by suppressing energy consumption required for cooling and heating without separately taking in a water-containing solution for cooling.

With the method of starting the water treatment apparatus according to the present disclosure, a starting time until reaching a steady state can be shortened while stably starting the water treatment apparatus that causes fresh water to permeate the draw solution from the water-containing solution.

### BRIEF DESCRIPTION OF DRAWINGS

FIG. 1 is a block diagram schematically illustrating a water treatment apparatus according to a first embodiment.

FIG. 2 is a block diagram schematically illustrating a water treatment apparatus according to a comparative example.

FIG. 3 is a block diagram schematically illustrating a water treatment apparatus according to a second embodiment.

FIG. 4 is a block diagram schematically illustrating a water treatment apparatus according to a third embodiment.

FIG. 5 is a block diagram schematically illustrating a water treatment apparatus according to a fourth embodiment.

FIG. 6 is a block diagram schematically illustrating a water treatment apparatus according to a fifth embodiment.

FIG. 7 is a block diagram schematically illustrating a water treatment apparatus according to a sixth embodiment, and a state at the time of starting thereof.

FIG. 8 is a block diagram schematically illustrating a water treatment apparatus according to a modification of the sixth embodiment.

FIG. 9 is a block diagram schematically illustrating a water treatment apparatus according to a seventh embodiment, and a preceding stage starting process at the time of starting.

FIG. 10 is a block diagram schematically illustrating a succeeding stage starting process at the time of starting of the water treatment apparatus according to the seventh embodiment.

FIG. 11 is a block diagram schematically illustrating a water treatment apparatus according to an eighth embodiment, and a state at the time of starting of the water treatment apparatus.

FIG. 12 is a block diagram schematically illustrating a water treatment apparatus according to a ninth embodiment.

FIG. 13 is a block diagram schematically illustrating a state at the time of starting of the water treatment apparatus according to the ninth embodiment.

### DESCRIPTION OF EMBODIMENTS

The following describes embodiments of the present disclosure with reference to the drawings. Throughout all the drawings of the following embodiments, the same or a corresponding portion is denoted by the same reference numeral. The present disclosure is not limited to the embodiments described below.

### First Embodiment

### Water Treatment Apparatus

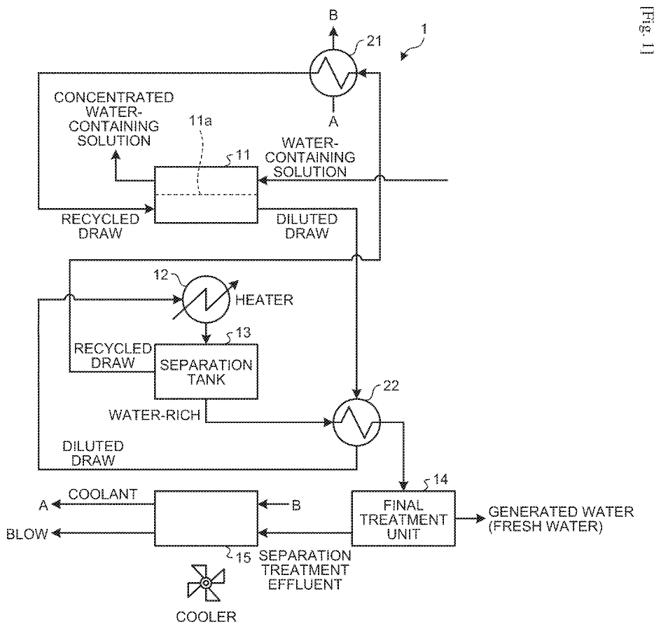

First, the following describes a water treatment apparatus according to a first embodiment. FIG. 1 is a block diagram schematically illustrating a water treatment apparatus 1 according to the first embodiment. As illustrated in FIG. 1, the water treatment apparatus 1 according to the first embodiment includes a membrane module 11, a heater 12, a separation tank 13, a final treatment unit 14, a cooling mechanism 15, and heat exchangers 21 and 22.

The membrane module 11 as a forward osmosis unit is, for example, a cylindrical or box-shaped container in which a semipermeable membrane 11a is disposed. The inner part of the membrane module 11 is partitioned into two chambers by the semipermeable membrane 11a. Examples of the form of the membrane module 11 include various forms such as a spiral module, a laminated module, and a hollow fiber module. As the membrane module 11, a known semipermeable membrane device can be used, and a commercial product can also be used.

The semipermeable membrane 11a disposed in the membrane module 11 is preferably a membrane that can selectively allow water to permeate. As the semipermeable membrane 11a, a forward osmosis (FO) membrane is used, and a reverse osmosis (RO) membrane can also be used. Material of a separation layer of the semipermeable membrane 11a is not limited, and examples thereof include cellulose acetate-based material, polyamide-based material, polyethyleneimine-based material, polysulfone-based material, and polybenzimidazole-based material. The semipermeable membrane 11a may be constituted of only one type (one layer) of material used for the separation layer, or may be constituted of two or more layers including a supporting layer that physically supports the separation layer and does not substantially contribute to separation.

Examples of the supporting layer include polysulfone-based material, polyketone-based material, polyethylene-based material, polyethylene terephthalate-based material, and common nonwoven fabric. The form of the semipermeable membrane 11a is not limited, and various forms of membrane can be used such as a flat membrane, a tubular membrane, or hollow fiber.

In the inner part of the membrane module 11, a water-containing solution can be allowed to flow into one of the chambers partitioned by the semipermeable membrane 11a, and a draw solution as a water-absorbing solution can be allowed to flow into the other one of the chambers. An introduction pressure of the draw solution into the membrane module 11 is equal to or larger than 0.1 MPa and equal to or smaller than 0.5 MPa, and in the first embodiment, 0.2 MPa, for example. The water-containing solution is, for example, seawater, salt water, brackish water, industrial effluent, produced water, sewage, or a water-containing solution containing water as a solvent obtained by performing filtration treatment on such kinds of water as needed.

As the draw solution, used is a solution mainly containing a temperature sensitive absorbent constituted of a polymer having at least one cloud point. The temperature sensitive absorbent is a substance that has an affinity for water and easily dissolves in water to increase an amount of water absorption at a low temperature while the amount of water absorption thereof is reduced as the temperature rises, and the substance becomes hydrophobic when the temperature becomes equal to or higher than a predetermined temperature to lower solubility. The temperature sensitive absorbent is utilized as various surface-active agents, dispersants, or emulsifiers.

In the first embodiment, the temperature sensitive absorbent is preferably a block copolymer or a random copolymer including at least a hydrophobic part and a hydrophilic part, and including at least one of an ethylene oxide group and a group constituted of propylene oxide and butylene oxide in a basic skeleton. Examples of the basic skeleton include a glycerol skeleton and a hydrocarbon skeleton. In the first embodiment, as the temperature sensitive absorbent, for example, used is an agent containing a polymer of ethylene oxide and propylene oxide. Regarding such a temperature sensitive absorbent, a temperature at which a water-soluble state and a water-insoluble state vary is called a cloud point. When the temperature of the draw solution rises and reaches the cloud point, the temperature sensitive absorbent that becomes hydrophobic is condensed to be cloudy.

In the first embodiment, the draw solution is used as an induction substance that induces water from the water-containing solution. Due to this, in the membrane module 11, water is induced to the draw solution from the water-containing solution, and the draw solution that is diluted (diluted draw solution) is allowed to flow out. On the other hand, in the membrane module 11, the water-containing solution that is concentrated when water is moved to the draw solution (concentrated water-containing solution) is allowed to flow out.

The heater 12 as a heating unit for the draw solution is disposed on an upstream side of the separation tank 13 along a flowing direction of the draw solution. The heater 12 heats, to a temperature equal to or higher than the cloud point, the diluted draw solution that flows out from the membrane module 11 and is subjected to heat exchange by the heat exchanger 22. The diluted draw solution that is heated to a temperature equal to or higher than the cloud point by the heater 12 is phase-separated into water and a temperature sensitive absorbent as a polymer.

In the separation tank 13 as a water separation unit, the diluted draw solution that is phase-separated by the heater 12 is separated into a solution mainly containing water (water-rich solution) and the draw solution that has water content lower than that of the water-rich solution and mainly contains the temperature sensitive absorbent. The draw solution having water content lower than that of the water-rich solution is supplied to the membrane module 11 via the heat exchanger 21 as a draw solution to be reused (hereinafter, referred to as a recycled draw solution).

The final treatment unit 14 as a separation treatment unit includes, for example, a coalescer, an activated carbon adsorption unit, an ultrafiltration membrane (UF membrane) unit, a nanofiltration membrane (NF membrane) unit, or a reverse osmosis membrane (RO membrane) unit. The final treatment unit 14 separates a remaining temperature sensitive absorbent from the water-rich solution that flows out as supernatant water from the separation tank 13 to generate fresh water as generated water. The final treatment unit 14 is configured to be able to supply, to the cooling mechanism 15 at a succeeding stage, at least part of or the entire polymer solution containing the temperature sensitive absorbent from which the generated water is separated, as separation treatment effluent having a temperature equal to or higher than 30° C. and equal to or lower than 50° C., for example, 45° C.

The cooling mechanism 15 as a cooling unit is, for example, configured to be able to allow a liquid such as water supplied from the outside (hereinafter, referred to as a recovered liquid) to flow out as a liquid that is cooled to a temperature lower than the temperature at the time of supply (hereinafter, referred to as a coolant). That is, the cooling mechanism 15 is configured to be able to allow the coolant such as cooling water to flow out, for example. Examples of the cooling mechanism 15 include a cooling tower. Specifically, as the cooling tower, various types of cooling towers can be employed. For example, exemplified is a cooling tower that brings air sucked from the outside by a cooling fan into contact with a liquid such as hot water scattered by a filler as the cooling fan is rotated, and cools the liquid by air. Herein, the temperature of the recovered liquid is equal to or higher than 35° C. and equal to or lower than 60° C., for example, about 45° C., which is cooled to be equal to or higher than 15° C. and equal to or lower than 45° C., for example, about 35° C. as a temperature of the coolant by the cooling mechanism 15. The cooling mechanism 15 is not limited to the cooling tower, and various coolers that can cool a liquid can be employed.

In the first embodiment, at least part of or the entire separation treatment effluent obtained by the final treatment unit 14 is supplied to the cooling mechanism 15. The separation treatment effluent is used as a supplementary liquid for supplementing a shortage of the coolant that is reduced due to evaporation, blowdown, and the like. That is, by controlling a flow rate of the separation treatment effluent supplied from the final treatment unit 14 and causing the separation treatment effluent to be the supplementary liquid, the coolant flowed out from the cooling mechanism 15 can be maintained at a predetermined flow rate. The cooling mechanism 15 may blow an excess of the coolant that has become excessive. As illustrated in FIG. 1 with the sign A, the cooling mechanism 15 supplies the coolant to the heat exchanger 21 using a water supply pump (not illustrated), for example. On the other hand, as illustrated in FIG. 1 with the sign B, the coolant that has passed through the heat exchanger 21 is returned to flow into the cooling mechanism 15 as the recovered liquid. Due to this, the cooling mechanism 15 is configured to be able to circulate the liquid as the coolant and the recovered liquid between the cooling mechanism 15 and the heat exchanger 21 using a water supply pump as a liquid feeding pump, for example.

The heat exchanger 21 as an inflow side heat exchange unit is disposed on the upstream side of the membrane module 11 and on a downstream side of the separation tank 13 along the flowing direction of the recycled draw solution. The coolant flowed out from the cooling mechanism 15 is allowed to flow into the heat exchanger 21. Due to this, the heat exchanger 21 performs heat exchange between the recycled draw solution having a high temperature flowed out from the separation tank 13 and the coolant having a low temperature flowed out from the cooling mechanism 15. The coolant the temperature of which is raised by the recycled draw solution that has passed through the heat exchanger 21 is returned to the cooling mechanism 15 again. The flow rate of the coolant flowing into the heat exchanger 21 is controlled so that the temperature of the recycled draw solution supplied to the membrane module 11 reaches a predetermined temperature. Specifically, by disposing a bypass valve (not illustrated) in the flow passage through which the coolant passes in the heat exchanger 21 to control the flow rate of the coolant flowing through the bypass valve, the temperature of the recycled draw solution is controlled to be the predetermined temperature. The temperature of the recycled draw solution supplied to the membrane module 11 is controlled to be equal to or higher than 25° C. and equal to or lower than 50° C., for example, about 40° C. as the predetermined temperature.

The heat exchanger 22 is disposed on the downstream side of the membrane module 11 along the flowing direction of the diluted draw solution. The heat exchanger 22 is disposed on the downstream side of the separation tank 13 along the flowing direction of the water-rich solution obtained by the separation tank 13. The heat exchanger 22 performs heat exchange between the diluted draw solution flowed out from the membrane module 11 and the water-rich solution obtained by the separation tank 13.

### Water Treatment Method

Next, the following describes a water treatment method using the water treatment apparatus 1 according to the first embodiment configured as described above.

### Forward Osmosis Process

The membrane module 11 as a forward osmosis unit performs a forward osmosis process. That is, in the membrane module 11, the water-containing solution is brought into contact with the recycled draw solution via the semipermeable membrane 11a. Due to this, in the membrane module 11, water in the water-containing solution passes through the semipermeable membrane 11a to move to the recycled draw solution due to an osmotic pressure difference. That is, from one chamber to which the water-containing solution is supplied in the membrane module 11, the concentrated water-containing solution flows out, the concentrated water-containing solution being concentrated when water moves to the recycled draw solution. From the other chamber to which the recycled draw solution is supplied, the diluted draw solution flows out, the diluted draw solution being diluted when water moves from the water-containing solution. In this case, heat exchange is also performed in the membrane module 11. The temperature rises from an inflow side of the water-containing solution toward an outflow side of the concentrated water-containing solution, and the temperature falls from the inflow side of the recycled draw solution toward the outflow side of the diluted draw solution.

### Inflow Side Heat Exchange Process

The heat exchanger 21 as an inflow side heat exchange unit performs an inflow side heat exchange process. That is, the coolant supplied from the cooling mechanism 15 is supplied to the heat exchanger 21. On the other hand, the recycled draw solution flowed out from the separation tank 13 is supplied to the heat exchanger 21. In the first embodiment, the temperature of the recycled draw solution is adjusted to a predetermined temperature equal to or higher than 25° C. and equal to or lower than 50° C., for example, about 40° C. by the heat exchanger 21. To lower the temperature of the recycled draw solution to the predetermined temperature, the flow rate of the coolant supplied from the cooling mechanism 15 is adjusted, the coolant to be subjected to heat exchange in the heat exchanger 21. That is, in the heat exchanger 21, the recycled draw solution is cooled by the coolant. On the other hand, in the heat exchanger 21, the coolant is heated by the recycled draw solution. A bypass valve (not illustrated) as an adjusting valve may be disposed in the heat exchanger 21 to adjust the flow rate of the coolant flowing into the heat exchanger 21. The recycled draw solution the temperature of which is lowered through heat exchange by the heat exchanger 21 is supplied to the other chamber of the membrane module 11. On the other hand, as illustrated in FIG. 1 with the sign B, the coolant subjected to heat exchange in the heat exchanger 21, the temperature of the coolant being raised to be equal to or higher than 35° C. and equal to or lower than 60° C., for example, 45° C., is returned to the cooling mechanism 15 as a recovered liquid.

### Coolant Generation Process

The cooling mechanism 15 as a cooling unit performs a coolant generation process. That is, the temperature of the coolant is raised by cooling the recycled draw solution flowed out from the separation tank 13 by the coolant in the heat exchanger 21. To the cooling mechanism 15, the temperature-raised coolant that has passed through the heat exchanger 21 is supplied as a recovered liquid. The temperature of the recovered liquid is equal to or higher than 35° C. and equal to or lower than 60° C., for example, 45° C., and the flow rate thereof is 2500 to 4800 L/h, for example. The cooling mechanism 15 cools the recovered liquid to a temperature equal to or higher than 15° C. and equal to or lower than 45° C., for example, 35° C., to generate the coolant. Additionally, the separation treatment effluent supplied from the final treatment unit 14 is supplied to the cooling mechanism 15. The temperature of the separation treatment effluent to be supplied is equal to or higher than 30° C. and equal to or lower than 50° C., for example, 45° C., and the flow rate thereof is equal to or higher than 5 L/h and equal to or lower than 500 L/h, for example, 85 L/h. The flow rate of the separation treatment effluent supplied from the final treatment unit 14 is adjusted and controlled by the cooling mechanism 15 in accordance with an amount of liquid discharged to the outside due to blowing, evaporation, and the like.

### Heating Process

The heater 12 as a heating unit performs a heating process. That is, the temperature of the diluted draw solution obtained by diluting the recycled draw solution through the forward osmosis process is raised in an outflow side heat exchange process (described later), and the diluted draw solution is further heated to a temperature equal to or higher than the cloud point by the heater 12. Due to this, at least part of the temperature sensitive absorbent is condensed, and phase separation is performed. The heating temperature in the heating process can be adjusted by controlling the heater 12. The heating temperature is equal to or lower than a boiling point of water, preferably equal to or lower than 100° C. under atmospheric pressure, and equal to or higher than the cloud point and equal to or lower than 100° C., for example, 88° C. in the first embodiment.

### Water Separation Process

The separation tank 13 as a water separation unit performs a water separation process. That is, in the separation tank 13, the diluted draw solution is separated into the water-rich solution having high water content and a concentrated recycled draw solution containing the temperature sensitive absorbent of high concentration. A pressure in the separation tank 13 is, for example, atmospheric pressure. The water-rich solution and the recycled draw solution can be phase-separated by being left standing at a solution temperature equal to or higher than the cloud point. In the first embodiment, the solution temperature in the separation tank 13 is equal to or higher than the cloud point and equal to or lower than 100° C., for example, 88° C. The draw solution separated from the diluted draw solution to be concentrated is supplied to the membrane module 11 as the recycled draw solution via the heat exchanger 21. Draw concentration of the recycled draw solution is, for example, 60 to 95%. On the other hand, the water-rich solution separated from the diluted draw solution is supplied to the final treatment unit 14 via the heat exchanger 22. For example, the water-rich solution has draw concentration of 1%, and contains 99% of water.

### Outflow Side Heat Exchange Process

The heat exchanger 22 as an outflow side heat exchange unit performs an outflow side heat exchange process. That is, the diluted draw solution flowed out from the membrane module 11 is firstly supplied to the heat exchanger 22. On the other hand, to the heat exchanger 22, the water-rich solution obtained by the separation tank 13 is supplied. In the first embodiment, the temperature of the water-rich solution is adjusted to a predetermined temperature, specifically, a temperature equal to or higher than 30° C. and equal to or lower than 50° C., for example, about 45° C. by the heat exchanger 22. As described above, the separation tank 13 performs the water separation process at the solution temperature equal to or higher than the cloud point and equal to or lower than 100° C. Thus, the temperature of the water-rich solution flowed out from the separation tank 13 is higher than that of the flowing-out diluted draw solution, the temperature of the diluted draw solution being lowered by the heat exchanger 21 and further lowered in the membrane module 11. On the other hand, a treatment temperature in the final treatment unit 14 at a succeeding stage is, for example, equal to or higher than 20° C. and equal to or lower than 50° C., preferably equal to or higher than 35° C. and equal to or lower than 45° C., and 45° C. in the first embodiment, for example. Thus, the heat exchanger 22 performs temperature adjustment to lower the temperature of the water-rich solution to the treatment temperature in the final treatment unit 14. That is, in the heat exchanger 22, the water-rich solution is cooled by the diluted draw solution, and the diluted draw solution is heated by the water-rich solution.

### Final Treatment Process

The final treatment unit 14 performs a final treatment process as a separation treatment process. That is, the temperature sensitive absorbent may remain in the water-rich solution separated by the separation tank 13. Thus, the final treatment unit 14 separates the polymer solution to be the separation treatment effluent from the water-rich solution. Due to this, generated water such as fresh water can be obtained. The generated water separated from the water-rich solution is supplied for a required use on the outside as an end product obtained from the water-containing solution. The separation treatment effluent separated from the generated water by the final treatment unit 14 is a polymer solution having draw concentration of about 0.5 to 25%, and at least part thereof is supplied to the cooling mechanism 15. In a case in which there is remaining separation treatment effluent that is not supplied to the cooling mechanism 15, the remaining separation treatment effluent can be discarded to the outside, or can be introduced into the diluted draw solution on the upstream side of the heater 12 or the heat exchanger 22.

### EXAMPLES AND COMPARATIVE EXAMPLE

Next, the following describes a first example of the water treatment apparatus 1 configured as described above and a comparative example according to the related art. In the first example, exemplified is a case of generating 300 L (300 L/h) of fresh water from 1100 L (1100 L/h) of seawater per hour using the water treatment apparatus.

### First Example

In the first example, seawater introduced into the water treatment apparatus 1 from the outside at a temperature of about 25° C. is supplied to the membrane module 11. The seawater is concentrated by the membrane module 11 while the temperature thereof is raised. The temperature of the seawater that is concentrated (concentrated seawater) is raised to a temperature of about 30° C., and the concentrated seawater is discharged from the membrane module 11 at a flow rate of 715 L/h. That is, in the membrane module 11, water is moved at a flow rate of 385 L/h.

The coolant cooled by the cooling mechanism 15 is supplied to the heat exchanger 21 at a flow rate of 2500 to 4800 L/h. The recycled draw solution is supplied to the heat exchanger 21, and heat-exchanged with the coolant having a low temperature of 35° C., so that the temperature thereof is lowered from 88° C. to 40° C. The temperature-lowered recycled draw solution is supplied to the membrane module 11 and diluted due to water movement, and flows out as a diluted draw solution. Herein, the flow rate of the recycled draw solution supplied to the membrane module 11 is 1100 L/h.

The temperature of the diluted draw solution flowed out from the membrane module 11 is 35° C., and the flow rate thereof is 1485 L/h. The diluted draw solution is heat-exchanged with the water-rich solution of 88° C. in the heat exchanger 22, and the temperature thereof is raised from a temperature of 35° C. to 48.6° C. The temperature-raised diluted draw solution is supplied to the heater 12 to be further heated, and the temperature thereof is raised from a temperature of 48.6° C. to 88° C. The diluted draw solution having a temperature of 88° C. is supplied to the separation tank 13, and is phase-separated into the recycled draw solution and the water-rich solution. The temperature of the recycled draw solution is 88° C., and the flow rate thereof is 1100 L/h. The temperature of the water-rich solution is 88° C., and the flow rate thereof is 385 L/h.

The water-rich solution flowed out from the separation tank 13 is supplied to the heat exchanger 22 to be heat-exchanged with the diluted draw solution of 35° C., and supplied to the final treatment unit 14 after the temperature thereof is lowered from 88° C. to 45° C. In the final treatment unit 14, the separation treatment effluent is separated at a flow rate of 85 L/h, and the generated water is obtained at a flow rate of 300 L/h. At least part of the obtained separation treatment effluent is supplied to the cooling mechanism 15. In the cooling mechanism 15, a predetermined amount of water is consumed due to blowing or evaporation, and the separation treatment effluent the amount of which is substantially the same as that of the consumed water is supplied. Accordingly, the generated water at a flow rate of 300 L/h can be obtained from the seawater at a flow rate of 1100 L/h.

### Comparative Example

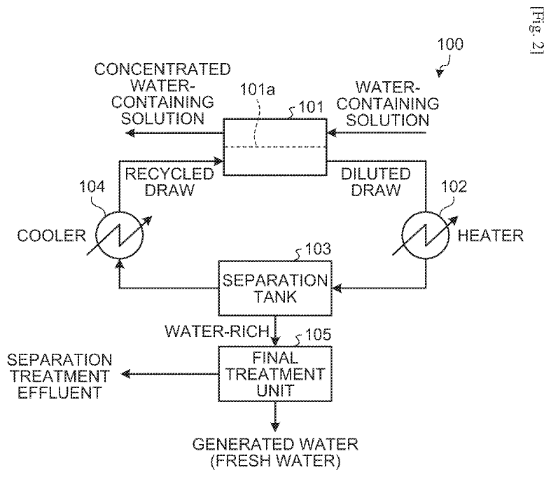

To be compared with the first example based on the first embodiment, the following describes, as a comparative example, an example in which a cooling mechanism for cooling the recycled draw solution is provided as a known water treatment apparatus. In the comparative example, described is an example of generating 300 L (300 L/h) of fresh water from 1100 L (1100 L/h) of seawater per hour using the water treatment apparatus. FIG. 2 is a block diagram schematically illustrating a water treatment apparatus 100 according to the comparative example.

As illustrated in FIG. 2, the water treatment apparatus 100 according to the comparative example includes a membrane module 101 including a semipermeable membrane 101a disposed therein, a heater 102, a separation tank 103, a cooler 104, and a final treatment unit 105. The membrane module 101, the heater 102, the separation tank 103, and the final treatment unit 105 are similar to the membrane module 11, the heater 12, the separation tank 13, and the final treatment unit 14 in the first embodiment, respectively. A different point from the water treatment apparatus 1 is that the cooler 104 is disposed on the downstream side of the separation tank 103 along the flowing direction of the recycled draw solution in the water treatment apparatus 100. The cooler 104 is a heat exchanger for cooling the recycled draw solution flowed out from the separation tank 103 with, for example, seawater of about 30° C. that is separately taken in by an intake pump and the like.

The water treatment apparatus 100 according to the comparative example supplies, to the membrane module 101, seawater the temperature of which is adjusted to a raw seawater temperature, or a temperature of 40° C., for example. The seawater concentrated by the membrane module 101 is discharged from the membrane module 101 at a flow rate of 715 L/h. That is, in the membrane module 101, water is moved at a flow rate of 385 L/h.

On the other hand, after the temperature of the recycled draw solution is adjusted to a temperature of 40° C. by the cooler 104, the recycled draw solution is supplied to the membrane module 101 to be diluted, and flows out as a diluted draw solution at a flow rate of 1485 L/h. The temperature of the diluted draw solution flowed out from the membrane module 101 is 40° C. The diluted draw solution is supplied to the heater 102 to be heated, and the temperature thereof is raised to a temperature of 88° C. The diluted draw solution having a temperature of 88° C. is supplied to the separation tank 103 to be phase-separated, and separated into the recycled draw solution having a temperature of 88° C. and a water-rich solution having a temperature of 88° C. The temperature of the recycled draw solution having a temperature of 88° C. is lowered to 40° C. by the cooler 104. Similarly, the water-rich solution having a temperature of 88° C. is cooled to about 45° C. by a cooler (not illustrated) as needed, and supplied to the final treatment unit 105 thereafter. In the final treatment unit 105, generated water is obtained at a flow rate of 300 L/h, and separation treatment effluent that is separated is discharged at a flow rate of 85 L/h. Accordingly, the generated water at a flow rate of 300 L/h is obtained from the seawater at a flow rate of 1100 L/h.

In the comparative example, the recycled draw solution separated by the separation tank 103 is cooled by the cooler 104, and is supplied to the membrane module 101 thereafter. Seawater is supplied to the cooler 104 using an intake pump. Thus, there are needs for equipment of the intake pump for supplying seawater to the cooler 104 and electric power for operating the intake pump. On the other hand, in the first example, the coolant cooled by the cooling mechanism 15 is supplied to the heat exchanger 21 using the water supply pump to cool the recycled draw solution. In this case, energy such as electric power required for the intake pump for separately taking in seawater is about two to three times the energy required for the water supply pump for supplying the coolant. From a viewpoint of using the water supply pump in the water treatment apparatus 1 even in a case of separately taking in seawater, energy consumption in the first example can be reduced to be about ¼ to ½ of that in the comparative example. Due to this, equipment cost can be reduced, and electric power cost can also be reduced as compared with a case of providing the intake pump.

A specific heat and density of the polymer water solution used in the first example and the comparative example are 3.2 kJ/kg·K and 1.05 kg/L, respectively. Due to this, energy required for heating the draw solution to 88° C. can be calculated. As the specific heat, used is an average specific heat at 40 to 88° C. of the polymer water solution, so that the specific heat is independent of the temperature of the draw solution. Contribution of the concentration and the temperature of the draw solution to the density is extremely small, so that influence of the concentration and the temperature is negligible.

In the comparative example, the diluted draw solution having a temperature of 40° C. is heated to a temperature of 88° C. by the heater 102. In this case, energy required for heating the diluted draw solution at a flow rate of 1485 L/h from 40° C. to 88° C. is as follows.

(3.2 kJ/kg·K×1.05 kg/L×1485 L/h×(88° C.−40° C.)=)2.40×10⁵ kJ/h Comparative example:

In this case, input energy required for the heater 102 is 66.5 kW.

On the other hand, in the first example, the diluted draw solution having a temperature of 48.6° C. is heated to a temperature of 88° C. by the heater 12. In this case, energy required for heating the diluted draw solution at a flow rate of 1485 L/h from 48.6° C. to 88° C. is as follows.

(3.2 kJ/kg·K×1.05 kg/L×1485 L/h×(88° C.−48.6° C.)=)1.96×10⁵ kJ/h First example:

In this case, the input energy required for the heater 12 is 54.6 kW, which is found to be able to be reduced by about 20% as compared with the comparative example.

As described above, according to the first embodiment, in the water treatment apparatus, the heat exchanger 21 is disposed for cooling the recycled draw solution with the coolant, and the recycled draw solution is cooled by circulating the coolant by the cooling mechanism 15. Due to this, the intake pump for taking in the water-containing solution for cooling is not required to be separately disposed for cooling the recycled draw solution flowed out from the separation tank 13, and energy balance in the water treatment apparatus 1 can be stabilized. Thus, energy required for taking in the water-containing solution can be reduced, and energy consumption of heating performed by the heater 12 can be reduced.

According to the first embodiment described above, the temperature of the recycled draw solution supplied to the membrane module 11 is adjusted to a desired temperature using the coolant cooled by the cooling mechanism 15. Due to this, the temperature of the water-containing solution can be brought closer to the temperature of the draw solution in the membrane module 11, so that treatment in the membrane module 11 can be stabilized. Additionally, before the diluted draw solution to be supplied to the separation tank 13 is heated to a temperature equal to or higher than the cloud point and equal to or lower than 100° C. by the heater 12, the temperature of the diluted draw solution flowed out from the membrane module 11 is raised by using the high-temperature water-rich solution flowed out from the separation tank 13. Due to this, a temperature width of a temperature raised by the heater 12 in heating the diluted draw solution can be narrowed, so that energy required for heating performed by the heater 12 can be reduced. Accordingly, energy consumption for cooling the recycled draw solution or heating the diluted draw solution can be reduced in the water treatment apparatus 1, and energy required for water treatment can be minimized.

To increase a movement amount of water in the membrane module 11, it is preferable that the osmotic pressure of the water-containing solution is low. To lower the osmotic pressure of the water-containing solution, it is preferable that the temperature of the water-containing solution flowing into the membrane module 11 is low. From this viewpoint, the recycled draw solution does not need to be cooled by using the water-containing solution flowing into the membrane module 11 because the recycled draw solution is cooled by using the coolant cooled by the cooling mechanism 15, so that the water-containing solution in a low temperature state supplied from the outside can be allowed to flow into the membrane module 11.

### Second Embodiment

### Water Treatment Apparatus and Water Treatment Method

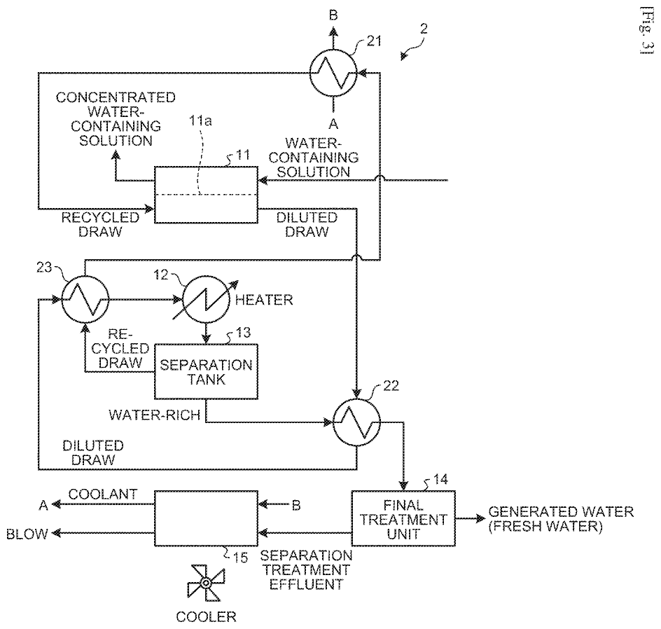

Next, the following describes a second embodiment. FIG. 3 illustrates a water treatment apparatus 2 according to the second embodiment. As illustrated in FIG. 3, the water treatment apparatus 2 includes the membrane module 11 including the semipermeable membrane 11a disposed therein, the heater 12, the separation tank 13, the final treatment unit 14, the cooling mechanism 15, and the heat exchangers 21 and 22 similarly to the first embodiment. A different point from the first embodiment is that the water treatment apparatus 2 further includes a heat exchanger 23.

In the water treatment apparatus 2, the heat exchanger 23 is disposed on the downstream side of the heat exchanger 22 and the upstream side of the heater 12 along the flowing direction of the diluted draw solution, and on the downstream side of the separation tank 13 and the upstream side of the heat exchanger 21 along the flowing direction of the recycled draw solution. The heat exchanger 23 as a succeeding stage heat exchange unit performs a succeeding stage heat exchange process. That is, in the water treatment method according to the second embodiment, the diluted draw solution flowed out from the membrane module 11 is firstly heat-exchanged with the high-temperature water-rich solution by the heat exchanger 22. Subsequently, as the succeeding stage heat exchange process, the diluted draw solution is heat-exchanged with the recycled draw solution having substantially the same temperature as the water-rich solution by the heat exchanger 23, and the temperature of the diluted draw solution is raised. Thereafter, the diluted draw solution is heated to a temperature equal to or higher than the cloud point and equal to or lower than 100° C. by the heater 12. Other configurations are the same as those in the first embodiment.

### Second Example

Next, the following describes a second example of the water treatment apparatus 2 configured as described above. In the second example, described is an example of generating 300 L (300 L/h) of fresh water from 1100 L (1100 L/h) of seawater per hour by using the water treatment apparatus.

In the second example, seawater introduced into the water treatment apparatus 2 from the outside at a temperature of about 25° C. is supplied to the membrane module 11. On the other hand, the recycled draw solution having a temperature of 40° C. that is heat-exchanged with the coolant by the heat exchanger 21 is supplied to the membrane module 11 at a flow rate of 1100 L/h to be diluted, and flows out as a diluted draw solution. In the membrane module 11, water is moved from seawater to the draw solution, and heat is moved from the draw solution to the seawater. In the membrane module 11, the seawater is concentrated while the temperature thereof is raised by the recycled draw solution. The temperature of the concentrated seawater is raised to a temperature of about 30° C., and the concentrated seawater is discharged from the membrane module 11 at a flow rate of 715 L/h. On the other hand, the temperature of the diluted draw solution flowed out from the membrane module 11 is 35° C., and the flow rate thereof is 1485 L/h. That is, in the membrane module 11, water is moved at a flow rate of 385 L/h. In the heat exchanger 21, the recycled draw solution that has been discharged from the separation tank 13 and passed through the heat exchanger 23 is heat-exchanged with the coolant supplied from the cooling mechanism 15 at a flow rate of 2500 to 4800 L/h.

Thereafter, the diluted draw solution is heated to a temperature of 48.6° C. by the heat exchanger 22, and supplied to the heat exchanger 23. The diluted draw solution is heat-exchanged with the recycled draw solution of 88° C. to be heated by the heat exchanger 23. The temperature of the diluted draw solution is raised from a temperature of 48.6° C. to 71° C. by the heat exchanger 23. Subsequently, the diluted draw solution is supplied to the heater 12 to be further heated, and the temperature thereof is raised from a temperature of 71° C. to 88° C.

Thereafter, the diluted draw solution is supplied to the separation tank 13, and phase-separated into the recycled draw solution and the water-rich solution. The temperature of the recycled draw solution is 88° C., and the flow rate thereof is 1100 L/h. The temperature of the water-rich solution is 88° C., and the flow rate thereof is 385 L/h. The temperature of the recycled draw solution is lowered from 88° C. to a predetermined temperature equal to or higher than 55° C. and lower than 88° C. by the heat exchanger 23, and further lowered to 40° C. by the heat exchanger 21. After the temperature of the water-rich solution is lowered from 88° C. to 45° C. by the heat exchanger 22, the water-rich solution is supplied to the final treatment unit 14. In the final treatment unit 14, generated water is obtained at a flow rate of 300 L/h. At least part of or the entire separation treatment effluent obtained by being separated from the generated water is supplied to the cooling mechanism 15. A flow rate at which the separation treatment effluent flows out is 85 L/h. In the cooling mechanism 15, a predetermined amount of the coolant is consumed by evaporation, and an excessive coolant, if present, is blown. Accordingly, the generated water at a flow rate of 300 L/h is obtained from the seawater at a flow rate of 1100 L/h.

In the second example, the diluted draw solution having a temperature of 71° C. is heated to a temperature of 88° C. by the heater 12. In this case, energy required for heating the diluted draw solution at a flow rate of 1485 L/h from 71° C. to 88° C. is as follows.

(3.2 kJ/kg·K×1.05 kg/L×1485 L/h×(88° C.−71° C.)=)8.48×10⁴ kJ/h Second example:

In this case, input energy required for the heater 12 is 23.2 kW, which is found to be about (23.2/66.5=) ⅓ of that in the comparative example described above, and about (23.2/54.6=) ½ of that in the first example.

According to the second embodiment, heat exchange is performed by the heat exchanger 21 using the coolant cooled by the cooling mechanism 15, and heat exchange is performed between the water-rich solution and the diluted draw solution by the heat exchanger 22, so that an effect similar to that of the first embodiment can be obtained. The temperature of the recycled draw solution flowed out from the separation tank 13 is lowered by the heat exchanger 23 while the temperature of the diluted draw solution to be supplied to the separation tank 13 is raised, so that the temperature width of the temperature raised by the heater 12 in heating the diluted draw solution can be further narrowed as compared with the first embodiment. Thus, the energy required for heating performed by the heater 12 can be further reduced, and the energy consumed in heating in the water treatment apparatus 2 can be further reduced.

### Third Embodiment

### Water Treatment Apparatus and Water Treatment Method

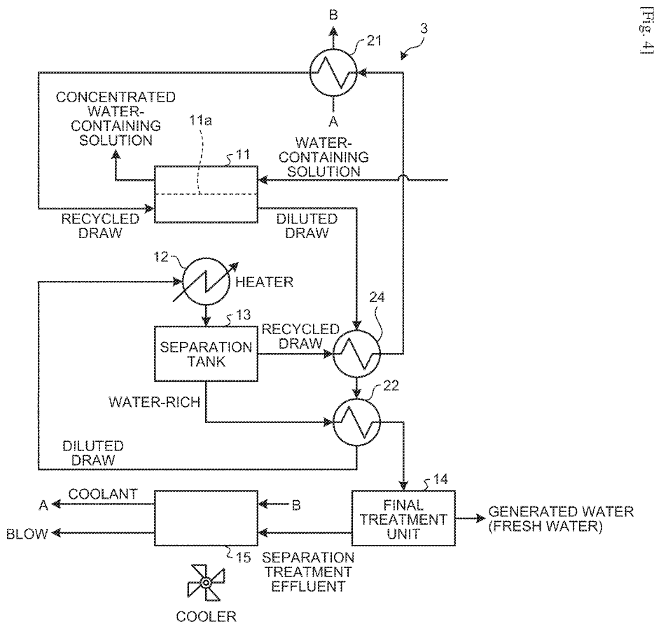

Next, the following describes a third embodiment. FIG. 4 illustrates a water treatment apparatus 3 according to the third embodiment. As illustrated in FIG. 4, the water treatment apparatus 3 includes the membrane module 11 including the semipermeable membrane 11a disposed therein, the heater 12, the separation tank 13, the final treatment unit 14, the cooling mechanism 15, and the heat exchangers 21 and 22 similarly to the first embodiment. A different point from the first embodiment is that the water treatment apparatus 3 further includes a heat exchanger 24.

In the water treatment apparatus 3, the heat exchanger 24 is disposed on the downstream side of the membrane module 11 and the upstream side of the heat exchanger 22 along the flowing direction of the diluted draw solution, and on the downstream side of the separation tank 13 and the upstream side of the heat exchanger 21 along the flowing direction of the recycled draw solution. The heat exchanger 24 as a preceding stage heat exchange unit performs a preceding stage heat exchange process. That is, in the water treatment method according to the third embodiment, as the preceding stage heat exchange process, the diluted draw solution flowed out from the membrane module 11 is heat-exchanged with the high-temperature recycled draw solution supplied from the separation tank 13 by the heat exchanger 24, and the temperature thereof is raised. Subsequently, the diluted draw solution is heat-exchanged with the high-temperature water-rich solution supplied from the separation tank 13 by the heat exchanger 22, and the temperature thereof is raised. Thereafter, the diluted draw solution is heated to a temperature equal to or higher than the cloud point and equal to or lower than 100° C. by the heater 12. Other configurations are the same as those in the first embodiment.

### Third Example

Next, the following describes a third example of the water treatment apparatus 3 configured as described above. In the third example, described is an example of generating 300 L (300 L/h) of fresh water from 1100 L (1100 L/h) of seawater per hour using the water treatment apparatus.

In the third example, seawater introduced into the water treatment apparatus 3 from the outside at a temperature of about 25° C. is supplied to the membrane module 11. The concentrated seawater concentrated by the membrane module 11 is discharged at a flow rate of 715 L/h. On the other hand, the recycled draw solution the temperature of which is lowered to a temperature of 40° C. by being heat-exchanged with the coolant by the heat exchanger 21 is supplied to the membrane module 11 at a flow rate of 1100 L/h, diluted due to movement of water from the seawater, and flows out as the diluted draw solution. That is, water is moved at a flow rate of 385 L/h in the membrane module 11. The temperature of the diluted draw solution flowed out from the membrane module 11 is 35° C., and the flow rate thereof is 1485 L/h. In the heat exchanger 21, the coolant supplied from the cooling mechanism 15 at a flow rate of 2500 to 4800 L/h is heat-exchanged with the recycled draw solution at a flow rate of 1100 L/h that has been discharged from the separation tank 13 and passed through the heat exchanger 24.

Thereafter, the diluted draw solution is heat-exchanged with the recycled draw solution of 88° C. supplied from the separation tank 13 in the heat exchanger 24, and the temperature of the diluted draw solution is raised to a temperature of 59.4° C. The temperature-raised diluted draw solution is supplied to the heat exchanger 22 from the heat exchanger 24. The diluted draw solution is heat-exchanged with the water-rich solution of 88° C. supplied from the separation tank 13 in the heat exchanger 22, and the temperature of the diluted draw solution is raised to a temperature of 66.7° C. Subsequently, the diluted draw solution is supplied to the heater 12 to be further heated, and the temperature thereof is raised from a temperature of 66.7° C. to 88° C. The diluted draw solution of 88° C. is supplied to the separation tank 13, and phase-separated into the recycled draw solution and the water-rich solution.

The temperature of the recycled draw solution separated by the separation tank 13 is 88° C., and the flow rate thereof is 1100 L/h. On the other hand, the temperature of the separated water-rich solution is 88° C., and the flow rate thereof is 385 L/h. After the recycled draw solution is supplied to the heat exchanger 24 from the separation tank 13, and the temperature thereof is lowered from 88° C. to 55.1° C., the recycled draw solution is heat-exchanged with the concentrated seawater by the heat exchanger 21, and the temperature thereof is lowered from 55.1° C. to 40° C. The temperature of the water-rich solution is lowered from 88° C. to 65.5° C. by the heat exchanger 22, and the water-rich solution is supplied to the final treatment unit 14. When heat resistance in the final treatment unit 14 is low such as a case of using a membrane treatment device as the final treatment unit 14, a cooling unit (not illustrated) may be further disposed between the heat exchanger 22 and the final treatment unit 14 to cool the water-rich solution to a predetermined temperature. In the final treatment unit 14, generated water at a flow rate of 300 L/h is obtained. At least part of or the entire separation treatment effluent obtained by being separated from the generated water is supplied to the cooling mechanism 15. The flow rate at which the separation treatment effluent flows out is 85 L/h. In the cooling mechanism 15, a predetermined amount of the coolant is consumed by evaporation, and an excessive coolant, if present, is blown. Accordingly, the generated water at a flow rate of 300 L/h is obtained from the seawater at a flow rate of 1100 L/h.

In the third example, the diluted draw solution having a temperature of 66.7° C. is heated to a temperature of 88° C. by the heater 12. In this case, energy required for heating the diluted draw solution at a flow rate of 1485 L/h from 66.7° C. to 88° C. is as follows.

(3.2 kJ/kg·K×1.05 kg/L×1485 L/h×(88° C.−66.7° C.)=)1.06×10⁵ kJ/h Third example:

In this case, input energy required for the heater 12 is 29.5 kW, which is found to be about (29.5/66.5=) ⅖ of that in the comparative example described above, and about (29.5/54.6=) ½ of that in the first example.

According to the third embodiment, heat exchange is performed by the heat exchanger 21 using the coolant cooled by the cooling mechanism 15, and heat exchange is performed between the water-rich solution and the diluted draw solution by the heat exchanger 22, so that an effect similar to that of the first embodiment can be obtained. The temperature of the diluted draw solution is raised while the temperature of the recycled draw solution to be supplied to the membrane module 11 is lowered by the heat exchanger 24, so that an effect similar to that of the second embodiment can be obtained.

### Fourth Embodiment

### Water Treatment Apparatus and Water Treatment Method

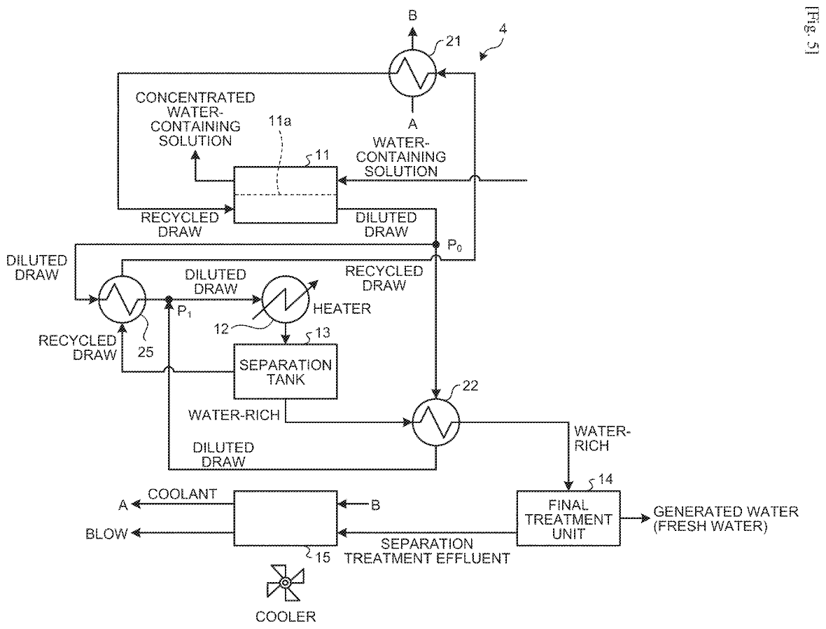

Next, the following describes a fourth embodiment. FIG. 5 illustrates a water treatment apparatus 4 according to the fourth embodiment. As illustrated in FIG. 5, the water treatment apparatus 4 includes the membrane module 11 including the semipermeable membrane 11a disposed therein, the heater 12, the separation tank 13, the final treatment unit 14, the cooling mechanism 15, and the heat exchangers 21 and 22 similarly to the first embodiment. A different point from the first embodiment is that the water treatment apparatus 4 further includes a heat exchanger 25.

In the water treatment apparatus 4, the heat exchanger 25 is disposed on the downstream side of the separation tank 13 and the upstream side of the heat exchanger 21 along the flowing direction of the recycled draw solution. A diverging point P₀ is disposed in piping on the downstream side of the membrane module 11 along the flowing direction of the diluted draw solution. At the diverging point P₀, the diluted draw solution diverges into at least two directions, one piece of piping is connected to the heat exchanger 22, and the other piece of piping is connected to the heat exchanger 25. On the other hand, a converging point P₁ at which diluted draw solutions that have passed through the heat exchangers 22 and 25 converge is disposed in the piping on the upstream side of the heater 12 along the flowing direction of the diluted draw solution. At the converging point P₁, the diverged diluted draw solutions converge. That is, each of the heat exchangers 22 and 25 as a parallel heat exchange unit is configured to be able to perform heat exchange between the diluted draw solution and another solution. The heat exchangers 22 and 25 perform parallel heat exchange process.

That is, in the water treatment method according to the fourth embodiment, the diluted draw solution flowed out from the membrane module 11 diverges at the diverging point P₀ in the piping on the upstream side of the heat exchangers 22 and 25. The diluted draw solution flowing in one piece of the diverged piping is supplied to the heat exchanger 22, heat-exchanged with high-temperature water-rich solution, and the temperature of the diluted draw solution is raised. The diluted draw solution flowing in the other one piece of the piping diverged at the diverging point P₀ is supplied to the heat exchanger 25, heat-exchanged with the recycled draw solution having substantially the same temperature as the water-rich solution, and the temperature of the diluted draw solution is raised. In other words, as the parallel heat exchange process, the diluted draw solution flowed out from the membrane module 11 diverges at the diverging point P₀, and the diverged diluted draw solutions pass through the heat exchangers 22 and 25 in parallel to be heat-exchanged with the water-rich solution and the recycled draw solution, respectively. Due to this, the flow rate of the diluted draw solution the temperature of which is raised by the recycled draw solution, and the flow rate of the diluted draw solution the temperature of which is raised by the water-rich solution can be reduced as compared with the second and the third embodiments, and the temperature width of the temperature to be raised can be widened.

The diluted draw solutions passed through the heat exchangers 22 and 25 in parallel converge at the converging point P₁ on the downstream side of the heat exchangers 22 and 25 and the upstream side of the heater 12. A flow rate ratio between one diluted draw solution and the other diluted draw solution diverged at the diverging point P₀ is adjusted by an adjusting valve (not illustrated) disposed in the vicinity of the diverging point P₀. Specifically, the flow rate ratio of the diluted draw solutions at the diverging point P₀ is adjusted by the adjusting valve so that the temperature of one diluted draw solution is substantially equal to the temperature of the other diluted draw solution at the converging point P₁. The diluted draw solution converged at the converging point P₁ is heated to a temperature equal to or higher than the cloud point and equal to or lower than 100° C. by the heater 12. Other configurations are the same as those in the first embodiment.

### Fourth Example

Next, the following describes a fourth example of the water treatment apparatus 4 configured as described above. In the fourth example, described is an example of generating 300 L (300 L/h) of fresh water from 1100 L (1100 L/h) of seawater per hour using the water treatment apparatus 4.

In the fourth example, seawater introduced into the water treatment apparatus 4 from the outside at a temperature of about 25° C. is supplied to the membrane module 11. The concentrated seawater concentrated by the membrane module 11 is discharged at a flow rate of 715 L/h. On the other hand, the recycled draw solution the temperature of which is lowered to a temperature of 40° C. by being heat-exchanged with the coolant by the heat exchanger 21 is supplied to the membrane module 11 at a flow rate of 1100 L/h, diluted due to movement of water from the seawater, and flows out as the diluted draw solution. That is, water is moved at a flow rate of 385 L/h in the membrane module 11. The temperature of the diluted draw solution flowed out from the membrane module 11 is 35° C., and the flow rate thereof is 1485 L/h. In the heat exchanger 21, the coolant supplied from the cooling mechanism 15 at a flow rate of 900 L/h is heat-exchanged with the recycled draw solution at a flow rate of 1100 L/h that has been discharged from the separation tank 13 and passed through the heat exchanger 25.

Thereafter, the diluted draw solution diverges at the diverging point P₀. One of the diverged diluted draw solutions is supplied to the heat exchanger 22 to be heat-exchanged with the water-rich solution having a temperature of 88° C., and the temperature of the diluted draw solution is raised from 35° C. to 75° C. The other one of the diverged diluted draw solutions is supplied to the heat exchanger 25 to be heat-exchanged with the recycled draw solution having a temperature of 88° C., which is substantially the same as the temperature of the water-rich solution, and the temperature of the diluted draw solution is raised from 35° C. to 75° C. The reason why the temperature of the diluted draw solution on the upstream side of the heater 12 is higher than that in the first to the third examples is as follows. That is, the diluted draw solution diverges in the middle of flow to be heat-exchanged in parallel, so that the flow rate of the diluted draw solution the temperature of which is raised by each of the heat exchangers 22 and 25 is reduced, and the temperature width of the temperature to be raised is widened. The diluted draw solutions the temperature of which is raised to 75° C. in parallel converge at the converging point P₁, are supplied to the heater 12 to be further heated, and the temperature thereof is raised from a temperature of 75° C. to 88° C.

Thereafter, the diluted draw solution is supplied to the separation tank 13, and phase-separated into the recycled draw solution and the water-rich solution. The temperature of the recycled draw solution is 88° C., and the flow rate thereof is 1100 L/h. The temperature of the water-rich solution is 88° C., and the flow rate thereof is 385 L/h. The temperature of the recycled draw solution is lowered from 88° C. to a predetermined temperature equal to or higher than 50° C. and lower than 88° C. by the heat exchanger 25, and lowered to 40° C. by the heat exchanger 21. After the temperature of the water-rich solution is lowered from 88° C. to 45° C. by the heat exchanger 22, the water-rich solution is supplied to the final treatment unit 14.

In the final treatment unit 14, generated water is obtained at a flow rate of 300 L/h. At least part of or the entire separation treatment effluent obtained by being separated from the generated water is supplied to the cooling mechanism 15. The flow rate at which the separation treatment effluent flows out is 85 L/h. In the cooling mechanism 15, a predetermined amount of the coolant is consumed by evaporation, and an excessive coolant, if present, is blown. Accordingly, the generated water at a flow rate of 300 L/h is obtained from the seawater at a flow rate of 1100 L/h.

In the fourth example, the diluted draw solution having a temperature of 75° C. is heated to a temperature of 88° C. by the heater 12. Energy required for heating the diluted draw solution at a flow rate of 1485 L/h from 75° C. to 88° C. is as follows.

(3.2 kJ/kg·K×1.05 kg/L×1485 L/h×(88° C.−75° C.)=)6.49×10⁴ kJ/h Fourth example:

In this case, input energy required for the heater 12 is 18.0 kW, which is found to be about (18.0/66.5=) 2/7 of that in the comparative example described above, about (18.0/54.6=) ⅓ of that in the first example, about (18.0/23.2=) ¾ of that in the second example, and about (18.0/29.5=) ⅗ of that in the third example.

According to the fourth embodiment, heat exchange is performed by the heat exchanger 21 using the coolant cooled by the cooling mechanism 15, and heat exchange is performed between the water-rich solution and the diluted draw solution by the heat exchanger 22, so that an effect similar to that of the first embodiment can be obtained. Additionally, the diluted draw solution flowed out from the membrane module 11 is caused to diverge, heat-exchanged with the recycled draw solution by the heat exchanger 25, and heat-exchanged with the water-rich solution by the heat exchanger 22, so that the temperatures of the diverged diluted draw solutions are raised in parallel. Due to this, the temperature of the diluted draw solution can be caused to be higher than that in the second and the third embodiments on the upstream side of the heater 12, so that the temperature width of the temperature raised in heating the diluted draw solution by the heater 12 can be narrowed as compared with that in the second and the third embodiments. Thus, the energy required for heating performed by the heater 12 can be further reduced, and energy consumed in heating in the water treatment apparatus 4 can be further reduced.

### Fifth Embodiment

### Water Treatment Apparatus and Water Treatment Method

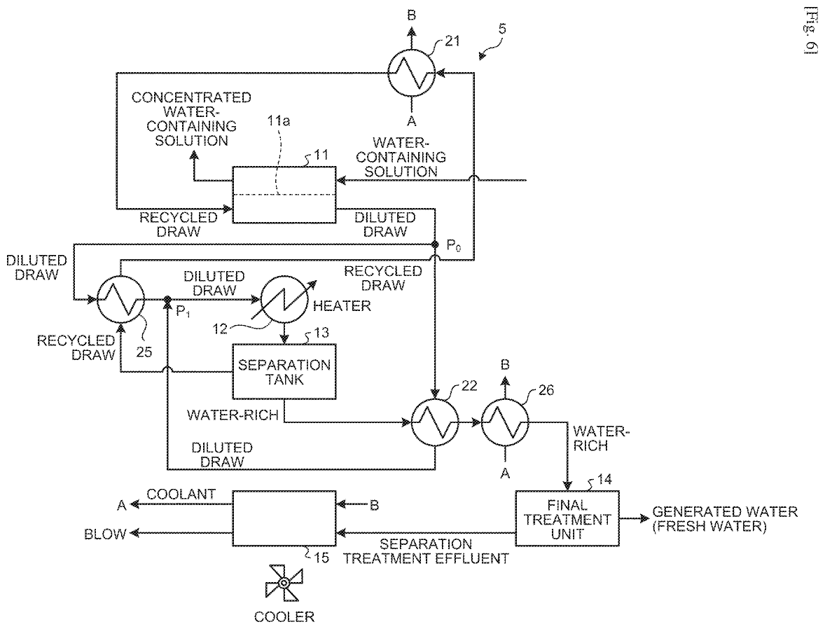

Next, the following describes a fifth embodiment. FIG. 6 illustrates a water treatment apparatus 5 according to the fifth embodiment. As illustrated in FIG. 6, the water treatment apparatus 5 includes the membrane module 11 including the semipermeable membrane 11a disposed therein, the heater 12, the separation tank 13, the final treatment unit 14, the cooling mechanism 15, and the heat exchangers 21, 22, and 25 similarly to the fourth embodiment. A different point from the fourth embodiment is that the water treatment apparatus 5 further includes a heat exchanger 26.

In the water treatment apparatus 5, the heat exchanger 26 is disposed on the downstream side of the heat exchanger 22 and the upstream side of the final treatment unit 14 along the flowing direction of the water-rich solution. The heat exchanger 26 as a heat exchange unit before final treatment performs heat exchange between the coolant supplied from the cooling mechanism 15 and the water-rich solution that has passed through the heat exchanger 22, and supplies the water-rich solution to the final treatment unit 14. The heat exchanger 26 performs heat exchange process before final treatment. That is, in the water treatment method according to the fifth embodiment, the temperature of the water-rich solution of about 88° C. flowed out from the separation tank 13 is lowered to a temperature equal to or higher than 30° C. and equal to or lower than 50° C., for example, 45° C., by the heat exchanger 22. Thereafter, as the heat exchange process before final treatment, the temperature of the water-rich solution is lowered to a temperature equal to or higher than 30° C. and equal to or lower than 45° C., for example, 35° C., by the heat exchanger 26, and the water-rich solution is supplied to the final treatment unit 14 thereafter. Other configurations are the same as those in the fourth embodiment.

### Fifth Example

Next, the following describes a fifth example of the water treatment apparatus 5 configured as described above. In the fifth example, described is an example of generating 300 L (300 L/h) of fresh water from 1100 L (1100 L/h) of seawater per hour using the water treatment apparatus 5.

In the fifth example, seawater introduced into the water treatment apparatus 5 from the outside at a temperature of about 25° C. is supplied to the membrane module 11. The concentrated seawater concentrated by the membrane module 11 is discharged at a flow rate of 715 L/h. On the other hand, the recycled draw solution the temperature of which is lowered to a temperature of 40° C. by being heat-exchanged with the coolant by the heat exchanger 21 is supplied to the membrane module 11 at a flow rate of 1100 L/h, diluted due to movement of water from the seawater, and flows out as the diluted draw solution. That is, water is moved at a flow rate of 385 L/h in the membrane module 11. The temperature of the diluted draw solution flowed out from the membrane module 11 is 35° C., and the flow rate thereof is 1485 L/h. In the heat exchanger 21, the coolant supplied from the cooling mechanism 15 at a flow rate of 500 L/h is heat-exchanged with the recycled draw solution at a flow rate of 1100 L/h that has flowed out from the separation tank 13 and passed through the heat exchanger 25.

Thereafter, the diluted draw solution diverges at the diverging point P₀. One of the diverged diluted draw solutions is supplied to the heat exchanger 22 to be heat-exchanged with the water-rich solution having a temperature of 88° C., and the temperature of the diluted draw solution is raised from 35° C. to 75° C. The other one of the diverged diluted draw solutions is supplied to the heat exchanger 25 to be heat-exchanged with the recycled draw solution having a temperature of 88° C., which is substantially the same as the temperature of the water-rich solution, and the temperature of the diluted draw solution is raised from 35° C. to 75° C. The diluted draw solutions the temperature of which is raised to 75° C. in parallel converge at the converging point P₁, are supplied to the heater 12 to be further heated, and the temperature thereof is raised from a temperature of 75° C. to 88° C.

Thereafter, the diluted draw solution is supplied to the separation tank 13, and phase-separated into the recycled draw solution and the water-rich solution. The temperature of the recycled draw solution is 88° C., and the flow rate thereof is 1100 L/h. The temperature of the water-rich solution is 88° C., and the flow rate thereof is 385 L/h. The temperature of the recycled draw solution is lowered from 88° C. to a predetermined temperature equal to or higher than 50° C. and lower than 88° C. by the heat exchanger 25, and lowered to 40° C. by the heat exchanger 21. On the other hand, the temperature of the water-rich solution is lowered from 88° C. to 45° C. by the heat exchanger 22, and further lowered to 35° C. by the heat exchanger 26. The coolant is supplied to the heat exchanger 26 at a flow rate of 400 L/h from the cooling mechanism 15 to be heat-exchanged with the water-rich solution. The temperature-lowered water-rich solution is supplied to the final treatment unit 14.

In this case, the coolant is distributed to the respective heat exchangers 21 and 26 from the cooling mechanism 15 by adjusting the flow rate of the coolant supplied to the heat exchangers 21 and 26. That is, adjusting valves (not illustrated) that can be controlled by a predetermined control unit are disposed between the outflow side of the cooling mechanism 15 and the respective heat exchangers 21 and 26. By controlling an opening of the adjusting valve by the control unit, flow rates of the coolant for the heat exchangers 21 and 26 are optionally controlled.

Distribution rates for the heat exchangers 21 and 26 are calculated from respective flow rates required for cooling the recycled draw solution or the water-rich solution to a predetermined temperature in the two heat exchangers 21 and 26. In the fifth example, a total flow rate of the coolant supplied to the heat exchangers 21 and 26 from the cooling mechanism 15 is 900 L/h. However, the total flow rate of the coolant and an inlet temperature of the coolant flowing into the heat exchangers 21 and 26 are variable, and outlet temperatures of the recycled draw solution flowing out from the heat exchanger 21 and the water-rich solution flowing out from the heat exchanger 26 are controlled to be constant at a predetermined temperature.

In the final treatment unit 14, generated water is obtained at a flow rate of 300 L/h. At least part of or the entire separation treatment effluent obtained by being separated from the generated water is supplied to the cooling mechanism 15. The flow rate at which the separation treatment effluent flows out is 85 L/h. In the cooling mechanism 15, a predetermined amount of the coolant is consumed by evaporation, and an excessive coolant, if present, is blown. Accordingly, the generated water at a flow rate of 300 L/h is obtained from the seawater at a flow rate of 1100 L/h.

In the fifth example, the diluted draw solution having a temperature of 75° C. is heated to a temperature of 88° C. by the heater 12. Energy required for heating the diluted draw solution at a flow rate of 1485 L/h from 75° C. to 88° C. is as follows.

(3.2 kJ/kg·K×1.05 kg/L×1485 L/h×(88° C.−75° C.)=)6.49×10⁴ kJ/h Fifth example:

In this case, input energy required for the heater 12 is 18.0 kW, which is found to be about (18.0/66.5=) 2/7 of that in the comparative example described above, about (18.0/54.6=) ⅓ of that in the first example, about (18.0/23.2=) ¾ of that in the second example, and about (18.0/29.5=) ⅗ of that in the third example.

According to the fifth embodiment, heat exchange is performed by the heat exchanger 21 using the coolant cooled by the cooling mechanism 15, and heat exchange is performed between the water-rich solution and the diluted draw solution by the heat exchanger 22, so that an effect similar to that of the first embodiment can be obtained. Additionally, the diluted draw solution flowed out from the membrane module 11 is caused to diverge, heat-exchanged with the recycled draw solution by the heat exchanger 25, heat-exchanged with the water-rich solution by the heat exchanger 22, and the temperatures of the diverged diluted solutions are raised in parallel, so that an effect similar to that of the fourth embodiment can be obtained. The temperature of the water-rich solution supplied to the final treatment unit 14 is lowered, so that, in a case of using a membrane filtration device as the final treatment unit 14, a service life of a filtration membrane is about one year in the fourth embodiment but about three years in the fifth embodiment. Accordingly, the service life of the membrane filtration device can be prolonged.

According to the first to the fifth embodiments described above, energy consumption required for cooling or heating can be suppressed, and energy balance can be stabilized. The suppression of energy consumption and the stabilization of energy balance in the water treatment apparatuses 1 to 5 are assumed to be obtained in a steady state in which the water treatment apparatuses 1 to 5 stably operate. On the other hand, at the time when the water treatment apparatus is initially started, the temperature of the entire system of the water treatment apparatus is different from that in the steady state. Thus, heat balance is lost in the system in starting operation of the water treatment apparatus, so that there has been a case in which a long time is required until the water treatment apparatus is caused to be in the steady state after starting, or the water treatment apparatus is hardly started. Thus, the inventor of the present disclosure has conceived a water treatment apparatus and a method of starting the water treatment apparatus for shortening a starting time until the steady state is obtained while stably starting the water treatment apparatus that causes fresh water to permeate the draw solution from the water-containing solution. In sixth to tenth embodiments described below, described is the water treatment apparatus and the method of starting the water treatment apparatus for shortening a starting time until the steady state is obtained while stably starting the water treatment apparatus.

### Sixth Embodiment

### Water Treatment Apparatus

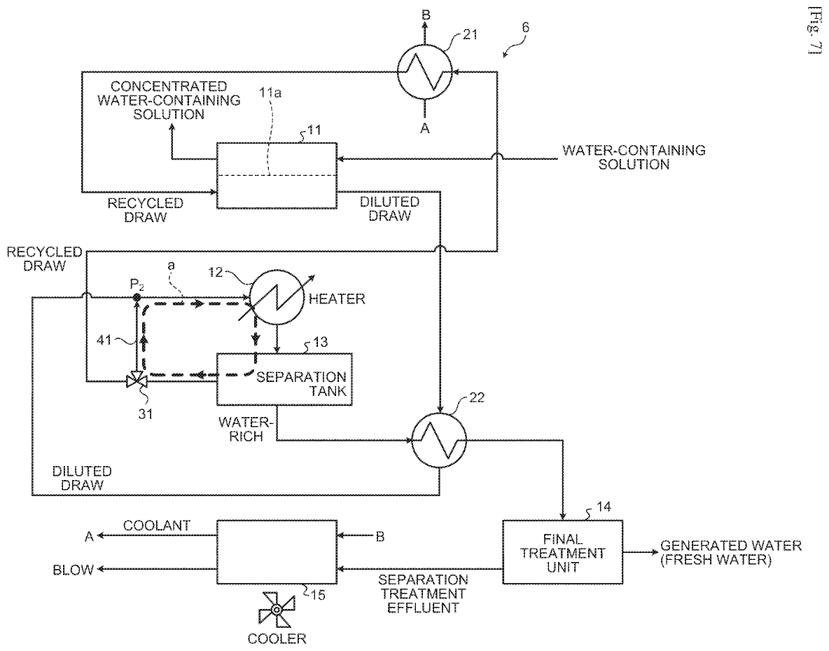

First, the following describes a water treatment apparatus according to the sixth embodiment. FIG. 7 is a block diagram schematically illustrating a water treatment apparatus 6 according to the sixth embodiment. As illustrated in FIG. 7, the water treatment apparatus 6 according to the sixth embodiment includes the membrane module 11, the heater 12, the separation tank 13, the final treatment unit 14, the cooling mechanism 15, the heat exchangers 21 and 22, and a cross valve 31. The configurations of the membrane module 11, the heater 12, the separation tank 13, the final treatment unit 14, the cooling mechanism 15, and the heat exchangers 21 and 22 are the same as those in the first embodiment. The draw solution and the temperature sensitive absorbent are also the same as those in the first embodiment.

In the water treatment apparatus 6, the cross valve 31 is disposed on the downstream side of the separation tank 13 and the upstream side of the heat exchanger 21 along the flowing direction of the recycled draw solution. A circulation flow passage 41 is disposed to communicate with the upstream side of the heater 12 along the flowing direction of the diluted draw solution from the cross valve 31 as a separation flow passage switching unit. The circulation flow passage 41 is a flow passage that can communicate with the heater 12 via an inflow point P₂. The circulation flow passage 41 may be caused to directly communicate with the heater 12. The cross valve 31 is configured to be able to switch between a flow passage for supplying the draw solution flowed out from the separation tank 13 to the heat exchanger 21 and the circulation flow passage 41 for supplying the draw solution to the heater 12.

### Water Treatment Method in Steady State

Next, the following describes the water treatment method in a steady state in which the water treatment apparatus 6 according to the sixth embodiment configured as described above stably operates after a sufficient time has elapsed after starting.

### Forward Osmosis Process

The membrane module 11 as a forward osmosis unit performs a forward osmosis process. That is, in the membrane module 11, the water-containing solution is brought into contact with the recycled draw solution via the semipermeable membrane 11a. Due to this, in the membrane module 11, water in the water-containing solution passes through the semipermeable membrane 11a to move to the recycled draw solution due to an osmotic pressure difference. That is, a concentrated water-containing solution that is concentrated when water moves to the recycled draw solution flows out from one chamber in the membrane module 11 to which the water-containing solution is supplied. A diluted draw solution that is diluted when water moves from the water-containing solution flows out from the other chamber to which the recycled draw solution is supplied.

### Inflow Side Heat Exchange Process

The heat exchanger 21 as an inflow side heat exchange unit performs an inflow side heat exchange process. That is, the coolant supplied from the cooling mechanism 15 is supplied to the heat exchanger 21. On the other hand, the recycled draw solution flowed out from the separation tank 13 is supplied to the heat exchanger 21. In the sixth embodiment, the temperature of the recycled draw solution is adjusted to a predetermined temperature equal to or higher than 25° C. and equal to or lower than 50° C., for example, about 40° C., by the heat exchanger 21. To lower the temperature of the recycled draw solution to the predetermined temperature, the flow rate of the coolant is adjusted, the coolant supplied from the cooling mechanism 15 to be subjected to heat exchange in the heat exchanger 21. That is, the recycled draw solution is cooled by the coolant in the heat exchanger 21. On the other hand, the coolant is heated by the recycled draw solution in the heat exchanger 21. A bypass valve (not illustrated) as an adjusting valve may be disposed in the heat exchanger 21 to adjust the flow rate of the coolant that flows into the heat exchanger 21. The recycled draw solution the temperature of which is lowered by being heat-exchanged by the heat exchanger 21 is supplied to the other chamber of the membrane module 11. On the other hand, as illustrated in FIG. 7 with the sign B, the coolant is returned to the cooling mechanism 15 as a recovered liquid, the coolant the temperature of which is raised to a temperature equal to or higher than 35° C. and equal to or lower than 60° C., for example, 45° C., by being heat-exchanged by the heat exchanger 21.

### Coolant Generation Process

The cooling mechanism 15 as a cooling unit performs a coolant generation process. That is, when the recycled draw solution flowed out from the separation tank 13 is cooled by the coolant in the heat exchanger 21, the temperature of the coolant is raised. The temperature-raised coolant that has passed through the heat exchanger 21 is supplied to the cooling mechanism 15 as a recovered liquid. The temperature of the recovered liquid is equal to or higher than 35° C. and equal to or lower than 60° C., for example, 45° C. The cooling mechanism 15 cools the recovered liquid to a temperature equal to or higher than 15° C. and equal to or lower than 45° C., for example, 35° C., to generate a coolant. Additionally, the separation treatment effluent supplied from the final treatment unit 14 is supplied to the cooling mechanism 15. The temperature of the separation treatment effluent to be supplied is, for example, equal to or higher than 20° C. and equal to or lower than 50° C., preferably equal to or higher than 35° C. and equal to or lower than 45° C., and in the sixth embodiment, 45° C., for example. The flow rate of the separation treatment effluent supplied from the final treatment unit 14 is adjusted and controlled in accordance with an amount of liquid discharged to the outside due to blowing, evaporation, and the like by the cooling mechanism 15.

### Heating Process

The heater 12 as a heating unit performs a heating process. That is, after the temperature of the diluted draw solution obtained by diluting the recycled draw solution in the forward osmosis process is raised in an outflow side heat exchange process described later, the diluted draw solution is further heated to a temperature equal to or higher than the cloud point by the heater 12. Due to this, at least part of the temperature sensitive absorbent is condensed, and phase separation is performed. A heating temperature in the heating process can be adjusted by controlling the heater 12. The heating temperature is equal to or lower than the boiling point of water, preferably equal to or lower than 100° C. under atmospheric pressure, and in the sixth embodiment, equal to or higher than the cloud point and equal to or lower than 100° C., for example, 88° C.

### Water Separation Process

The separation tank 13 as a water separation unit performs a water separation process. That is, in the separation tank 13, the diluted draw solution heated by the heater 12 is separated into a water-rich solution having high water content and a concentrated recycled draw solution containing the temperature sensitive absorbent of high concentration. A pressure in the separation tank 13 is, for example, atmospheric pressure. The water-rich solution and the recycled draw solution can be phase-separated by being left standing at a solution temperature equal to or higher than the cloud point. In the sixth embodiment, the solution temperature in the separation tank 13 is equal to or higher than the cloud point and equal to or lower than 100° C., for example, 88° C. The draw solution separated from the diluted draw solution to be concentrated is supplied to the membrane module 11 as the recycled draw solution via the heat exchanger 21. Draw concentration of the recycled draw solution is, for example, 50 to 95%. On the other hand, the water-rich solution separated from the diluted draw solution is supplied to the final treatment unit 14 via the heat exchanger 22. For example, the water-rich solution has draw concentration of 1%, and contains 99% of water.

### Outflow Side Heat Exchange Process

The heat exchanger 22 as an outflow side heat exchange unit performs an outflow side heat exchange process. That is, the diluted draw solution flowed out from the membrane module 11 is firstly supplied to the heat exchanger 22. On the other hand, to the heat exchanger 22, the water-rich solution obtained by the separation tank 13 is supplied. In the sixth embodiment, the temperature of the water-rich solution is adjusted to a predetermined temperature, specifically, a temperature equal to or higher than 30° C. and equal to or lower than 50° C., for example, about 45° C., by the heat exchanger 22. As described above, the separation tank 13 performs the water separation process at the solution temperature equal to or higher than the cloud point and equal to or lower than 100° C. The temperature of the water-rich solution flowed out from the separation tank 13 is higher than that of the diluted draw solution flowed out from the membrane module 11, and is lowered by being heat-exchanged with the diluted draw solution by the heat exchanger 22. On the other hand, a treatment temperature in the final treatment unit 14 at a succeeding stage is, for example, equal to or higher than 20° C. and equal to or lower than 50° C., preferably equal to or higher than 35° C. and equal to or lower than 45° C., and 45° C. in the sixth embodiment, for example. Thus, the heat exchanger 22 performs temperature adjustment to lower the temperature of the water-rich solution to the treatment temperature in the final treatment unit 14. That is, in the heat exchanger 22, the water-rich solution is cooled by the diluted draw solution, and the diluted draw solution is heated by the water-rich solution.

### Final Treatment Process

The final treatment unit 14 performs a final treatment process as a separation treatment process. That is, the temperature sensitive absorbent may remain in the water-rich solution separated by the separation tank 13. Thus, the final treatment unit 14 separates the polymer solution to be the separation treatment effluent from the water-rich solution. Accordingly, generated water such as fresh water can be obtained. The generated water separated from the water-rich solution is supplied for a required use on the outside as an end product obtained from the water-containing solution. The separation treatment effluent separated from the generated water by the final treatment unit 14 is a polymer solution having draw concentration of about 0.5 to 25%, and at least part thereof is supplied to the cooling mechanism 15. In a case in which there is remaining separation treatment effluent that is not supplied to the cooling mechanism 15, the remaining separation treatment effluent can be discarded to the outside, or can be introduced into the diluted draw solution on the upstream side of the heater 12 or the heat exchanger 22.

### Method of Starting Water Treatment Apparatus

Next, the following describes a method of starting the water treatment apparatus 6 at a preceding stage for causing the water treatment apparatus 6 to operate in accordance with the water treatment method in the steady state described above. The starting method according to the sixth embodiment is a method of starting operation of the water treatment apparatus 6 in the steady state after causing the draw solution to be used to circulate between the heater 12 and the separation tank 13 to be preliminarily heated at the time of starting the water treatment apparatus 6.

### Preparing Process

First, the water treatment apparatus 6 performs a preparing process for starting. That is, as illustrated in FIG. 7, the cross valve 31 is switched so that the draw solution flowed out from the separation tank 13 flows into the upstream side of the heater 12 through the cross valve 31. On the other hand, the draw solution containing the temperature sensitive absorbent and water having a temperature of about 25° C. for example, which is an environment temperature, is put into the separation tank 13. Specifically, in the separation tank 13, by diluting, with water, the temperature sensitive absorbent having polymer concentration equal to or higher than 50% and equal to or lower than 100%, for example, about 90%, the draw solution having polymer concentration equal to or higher than 40% and equal to or lower than 95%, for example, about 60%, is stored therein. Additionally, in the separation tank 13, a flow passage through which the water-rich solution as supernatant water flows out is blocked. On the other hand, the heater 12 is caused to operate to allow the draw solution to be heated.

### Separation and Circulation Process

Next, a separation and circulation process is performed by the separation tank 13 and the heater 12. A flow passage of the draw solution in the separation and circulation process is denoted by a bold dashed line a in FIG. 7. First, for example, the draw solution is caused to flow out from the separation tank 13 by a water supply pump (not illustrated). The flowed-out draw solution is supplied to the heater 12 through the cross valve 31 and the circulation flow passage 41. The heater 12 performs a starting and heating process. That is, the draw solution flowed out from the separation tank 13 is heated to a temperature equal to or higher than the cloud point, for example, by the heater 12. Specifically, the draw solution put into the separation tank 13 in the preparing process is heated by the heater 12. A heating temperature in the starting and heating process can be adjusted by controlling the heater 12. The polymer concentration of the draw solution is uniquely related to the temperature of the draw solution equal to or higher than the cloud point, that is, the concentration of the draw solution is determined depending on the temperature of the draw solution after heating, so that the polymer concentration of the draw solution can be derived from the temperature of the draw solution. The heated draw solution is supplied to the separation tank 13. By repeatedly performing successive heating such that the draw solution is supplied from the separation tank 13 to the heater 12 through the circulation flow passage 41 to be heated, the temperature of the draw solution in the separation tank 13 is raised from a temperature of about 25° C. for example, which is an environment temperature at the time of putting in the draw solution, to a temperature equal to or higher than the cloud point and equal to or lower than the boiling point, for example, 88° C.

After the temperature in the separation tank 13 is raised to a temperature equal to or higher than the cloud point, for example, 88° C., the recycled draw solution is supplied to the membrane module 11 from the separation tank 13 via the heat exchanger 21 by switching the cross valve 31. At the same time, by supplying the water-containing solution to the membrane module 11, the forward osmosis process is started by the membrane module 11. On the other hand, by opening the flow passage through which the supernatant water flows out in the separation tank 13 when the forward osmosis process is started, the water-rich solution is supplied to the final treatment unit 14 via the heat exchanger 22, and final treatment is started. Accordingly, the water treatment apparatus 6 is started, and water treatment is started in the steady state described above. The recycled draw solution and the water-containing solution may be supplied to the membrane module 11 at the same time, or any one thereof may be supplied earlier. Supply of the recycled draw solution to the membrane module 11, and supply of the water-rich solution to the final treatment unit 14 and starting of the final treatment unit 14 may be performed at the same time, or any one thereof may be performed earlier.

### Modification

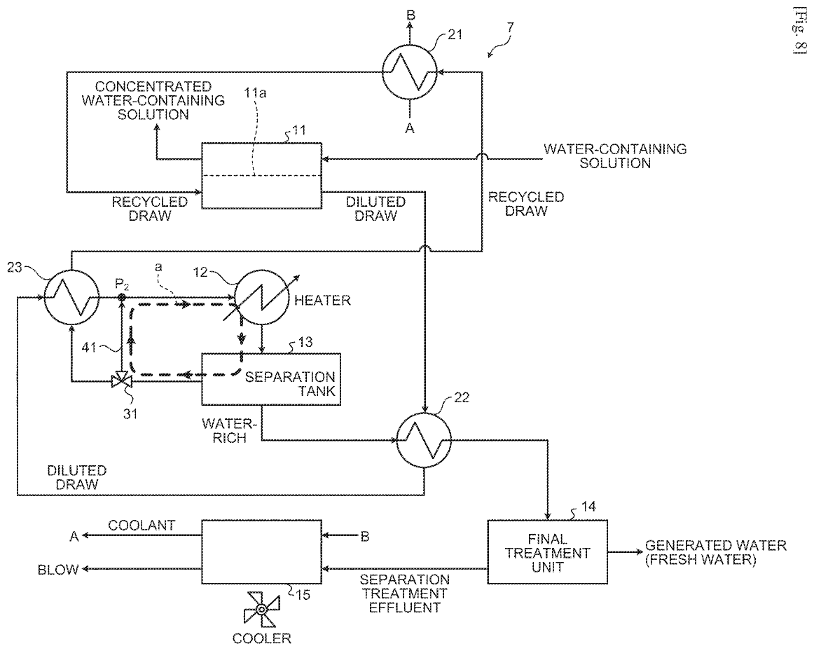

Next, the following describes a modification of the sixth embodiment. FIG. 8 is a block diagram schematically illustrating a water treatment apparatus according to the modification of the sixth embodiment.

As illustrated in FIG. 8, in a water treatment apparatus 7 according to the modification, the heat exchanger 23 is disposed on the downstream side of the separation tank 13 and the upstream side of the heat exchanger 21 along the flowing direction of the recycled draw solution, and on the downstream side of the heat exchanger 22 and the upstream side of the heater 12 along the flowing direction of the diluted draw solution.

The heat exchanger 23 as a succeeding stage heat exchange unit performs a succeeding stage heat exchange process. That is, in the water treatment method with the water treatment apparatus 7 according to the modification, the diluted draw solution flowed out from the membrane module 11 is firstly heat-exchanged with a high-temperature water-rich solution by the heat exchanger 22. Subsequently, as the succeeding stage heat exchange process, the diluted draw solution is heat-exchanged with the recycled draw solution having substantially the same temperature as the water-rich solution by the heat exchanger 23, and the temperature of the diluted draw solution is raised. Thereafter, the diluted draw solution is heated to a temperature equal to or higher than the cloud point and equal to or lower than 100° C. by the heater 12. Other processes of the water treatment method in the steady state are the same as those in the sixth embodiment.

In the water treatment apparatus 7 according to the modification, the cross valve 31 is disposed on the downstream side of the separation tank 13 and the upstream side of the heat exchanger 23 along the flowing direction of the recycled draw solution. The circulation flow passage 41 communicates, from the cross valve 31, with the inflow point P₂ on the downstream side of the heat exchanger 23 and the upstream side of the heater 12 along the flowing direction of the diluted draw solution. Other configurations and the starting method of the water treatment apparatus 7 according to the modification are the same as those in the sixth embodiment.

In the related art, when the water treatment apparatuses 6 and 7 are started without performing preliminary heating, the draw solution having low polymer concentration before being phase-separated is supplied to the membrane module 11. Thus, until temperature balance is stabilized in the system of the water treatment apparatuses 6 and 7, an amount of water moving from the water-containing solution to the draw solution is extremely small. In this case, the temperature of the draw solution circulating in the water treatment apparatuses 6 and 7 is gradually raised, phase separation is started at the time when the temperature of the draw solution in the separation tank 13 exceeds the cloud point, and the amount of water moving in the membrane module 11 is increased. However, phase separation of the draw solution in the separation tank 13 is insufficient until the temperature of the draw solution in the separation tank 13 reaches a predetermined temperature, that is, the cloud point, so that a state in which the water-rich solution cannot be supplied to the final treatment unit 14 is continued. In this case, an amount of the solution stored in the separation tank 13 is increased, so that the water treatment apparatuses 6 and 7 are hardly operated at the time when the separation tank 13 becomes full.

On the other hand, according to the sixth embodiment described above, at the time of starting the water treatment apparatuses 6 and 7, preliminary heating is performed such that the draw solution is circulated between the heater 12 and the separation tank 13 to be heated to a predetermined temperature equal to or higher than the cloud point using the cross valve 31 and the circulation flow passage 41. Due to this, the draw solution and the water-rich solution as supernatant water can be separated from each other in the separation tank 13 at the time of starting the water treatment apparatus 6, so that the draw solution of high polymer concentration can be supplied to the membrane module 11 at the time of starting the water treatment apparatuses 6 and 7. Thus, water can be rapidly moved from the water-containing solution to the draw solution via the semipermeable membrane 11a in the membrane module 11, and a time until the temperature balance in the system of the water treatment apparatuses 6 and 7 is stabilized can be shortened.

### Seventh Embodiment

### Water Treatment Apparatus

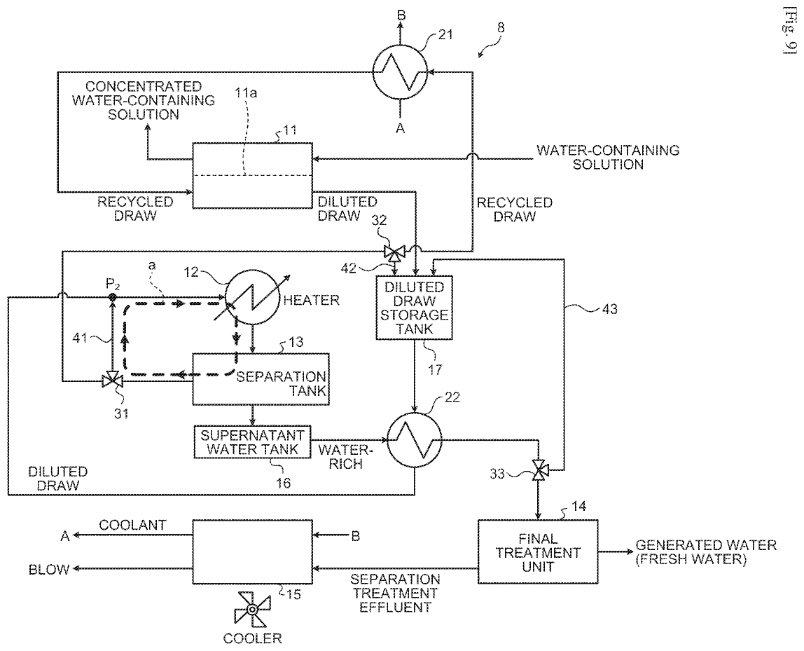

Next, the following describes a seventh embodiment. FIG. 9 illustrates a water treatment apparatus 8 according to the seventh embodiment. As illustrated in FIG. 9, the water treatment apparatus 8 includes the membrane module 11 including the semipermeable membrane 11a disposed therein, the heater 12, the separation tank 13, the final treatment unit 14, the cooling mechanism 15, the heat exchangers 21 and 22, and the cross valve 31 similarly to the sixth embodiment. A different point from the sixth embodiment is that the water treatment apparatus 8 further includes a supernatant water tank 16, a diluted draw storage tank 17, and cross valves 32 and 33.

The supernatant water tank 16 is disposed on the downstream side of the separation tank 13 and the upstream side of the heat exchanger 22 along the flowing direction of the water-rich solution. The diluted draw storage tank 17 is disposed on the downstream side of the membrane module 11 and the upstream side of the heat exchanger 22 along the flowing direction of the diluted draw solution. The diluted draw storage tank 17 as a diluted draw storage unit is configured to be able to at least temporarily store the diluted draw solution flowed out from the membrane module 11.

The cross valve 32 as an upstream side switching unit is disposed on the downstream side of the cross valve 31 and the upstream side of the heat exchanger 21 along the flowing direction of the draw solution flowed out from the separation tank 13. The cross valve 32 communicates with the diluted draw storage tank 17 via an upstream side bypass flow passage 42 through which the draw solution can flow into the diluted draw storage tank 17. The cross valve 32 is configured to be able to switch between a flow passage for supplying, to the heat exchanger 21, the draw solution that has flowed out from the separation tank 13 and passed through the cross valve 31, and the upstream side bypass flow passage 42 for supplying the draw solution to the diluted draw storage tank 17.

The cross valve 33 as a downstream side switching unit is disposed on the downstream side of the heat exchanger 22 and the upstream side of the final treatment unit 14 along the flowing direction of the water-rich solution flowed out from the supernatant water tank 16. The cross valve 33 communicates with the diluted draw storage tank 17 via a downstream side bypass flow passage 43 through which the supernatant water, that is, the water-rich solution can flow into the diluted draw storage tank 17. The cross valve 33 is configured to be able to switch between a flow passage for supplying, to the final treatment unit 14, the water-rich solution that has flowed out from the supernatant water tank 16 and passed through the heat exchanger 22, and the downstream side bypass flow passage 43 for supplying the water-rich solution to the diluted draw storage tank 17. Other configurations are the same as those in the sixth embodiment.

### Water Treatment Method in Steady State

Next, the following describes a water treatment method in the steady state according to the seventh embodiment performed by the water treatment apparatus 8 configured as described above. That is, in the water treatment method according to the seventh embodiment, the diluted draw solution flowed out from the membrane module 11 flows into the diluted draw storage tank 17 to be supplied to the heat exchanger 22. The water-rich solution as supernatant water flowed out from the separation tank 13 flows into the supernatant water tank 16 to be supplied to the heat exchanger 22. Other processes of the water treatment method in the steady state are the same as those in the sixth embodiment.

### Method of Starting Water Treatment Apparatus

### Preceding Stage Starting Process

Next, the following describes a method of starting the water treatment apparatus 8 according to the seventh embodiment. That is, in the seventh embodiment, the preparing process is firstly performed, and the separation and circulation process is performed thereafter similarly to the sixth embodiment. In the seventh embodiment, the separation and circulation process according to the sixth embodiment becomes the preceding stage starting process as the first half of the starting process. In the preceding stage starting process, the draw solution in the separation tank 13 is supplied to the heater 12 to be heated through the circulation flow passage 41 following the flow passage indicated by the bold dashed line a in FIG. 9, and is circulated in the separation tank 13. Due to this, the temperature of the draw solution in the separation tank 13 is raised from an environment temperature to a temperature equal to or higher than the cloud point.

### Succeeding Stage Starting Process

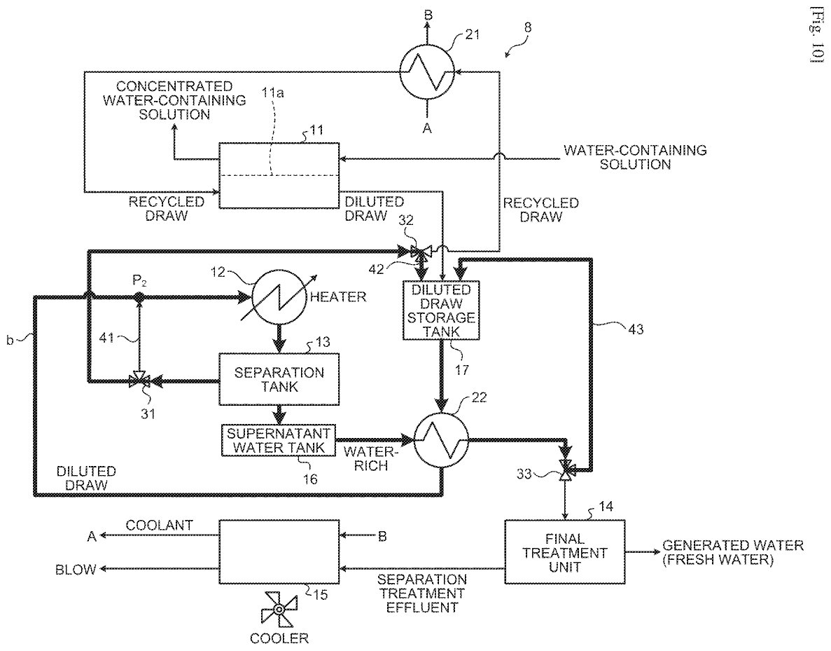

Thereafter, the succeeding stage starting process is performed. FIG. 10 is a block diagram schematically illustrating the succeeding stage starting process performed by the water treatment apparatus 8 according to the seventh embodiment. In FIG. 10, a flow passage of the draw solution and the water-rich solution in the circulating and heating process is denoted by a bold solid line b. First, in the seventh embodiment, the draw solution containing the temperature sensitive absorbent and water having a temperature of about 25° C. for example, which is an environment temperature, is put into the diluted draw storage tank 17. Specifically, for example, in the diluted draw storage tank 17, by diluting the temperature sensitive absorbent having polymer concentration of about 90% with water, the draw solution having polymer concentration of about 50% is stored therein. The draw solution may be put into the diluted draw storage tank 17 before or after the preparing process described above, or before or after the preceding stage starting process.

### Switching Process

Next, the cross valves 32 and 33 perform a switching process. That is, the cross valve 32 is switched so that the draw solution that has flowed out from the separation tank 13 and passed through the cross valve 31 can flow into the diluted draw storage tank 17 through the cross valve 32. On the other hand, the cross valve 33 is switched so that the water-rich solution that has flowed out from the separation tank 13 and passed through the supernatant water tank 16 and the heat exchanger 22 can flow into the diluted draw storage tank 17 through the cross valve 33.

### Circulating and Heating Process

Next, the heater 12, the separation tank 13, the supernatant water tank 16, the diluted draw storage tank 17, and the heat exchanger 22 perform a circulating and heating process. That is, as illustrated in FIG. 10, by switching the cross valve 31, the draw solution heated in the preceding stage starting process flows out from the separation tank 13, and is supplied to the diluted draw storage tank 17 to be stored through the cross valve 32 and the upstream side bypass flow passage 42 as an upstream side bypass process. In the diluted draw storage tank 17, the stored draw solution including the draw solution supplied from the separation tank 13 is mixed with the water-rich solution that has flowed in through the downstream side bypass flow passage 43 (described later). The temperature of the draw solution in the diluted draw storage tank 17 is raised from an environment temperature of about 25° C., for example. The draw solution stored in the diluted draw storage tank 17 is supplied to the heat exchanger 22 by a water supply pump (not illustrated), for example. The heat exchanger 22 performs an outflow side temperature raising process. That is, the draw solution flowed out from the diluted draw storage tank 17 is heat-exchanged with a high-temperature water-rich solution flowed out from the separation tank 13, the high-temperature water-rich solution having a temperature equal to or higher than the cloud point, for example, about 88° C., and the temperature of the draw solution is raised. The draw solution the temperature of which is raised by the heat exchanger 22 is supplied to the heater 12. In the heater 12, as a heating process, the temperature-raised draw solution is further heated to a temperature equal to or higher than the cloud point and equal to or lower than the boiling point. The heated draw solution is supplied to the separation tank 13. That is, the draw solution flowed out from the separation tank 13 is circulated to the separation tank 13 via the cross valves 31 and 32, the diluted draw storage tank 17, the heat exchanger 22, and the heater 12.

On the other hand, the high-temperature water-rich solution of about 88° C., for example, flowed out from the separation tank 13 flows into the supernatant water tank 16 to be stored. Thereafter, the water-rich solution is supplied to the heat exchanger 22 by a water supply pump (not illustrated), for example, and heat-exchanged with the low-temperature draw solution supplied from the diluted draw storage tank 17. The water-rich solution the temperature of which is lowered by the heat exchanger 22 flows into the diluted draw storage tank 17 through the cross valve 33 and the downstream side bypass flow passage 43 as a downstream side bypass process. In the diluted draw storage tank 17, the water-rich solution that has flowed therein is mixed with the stored draw solution including the draw solution supplied from the separation tank 13. Due to this, the water-rich solution is mixed into the draw solution. The draw solution stored in the diluted draw storage tank 17 is supplied to the heat exchanger 22 by a water supply pump (not illustrated), for example, and heat-exchanged with the high-temperature water-rich solution that has flowed out from the separation tank 13, the high-temperature water-rich solution having a temperature equal to or higher than the cloud point, for example, about 88° C. The draw solution the temperature of which is raised by the heat exchanger 22 is supplied to the heater 12. The temperature-raised draw solution is further heated by the heater 12. The heated draw solution is supplied to the separation tank 13. That is, the water-rich solution flowed out from the separation tank 13 is supplied to the diluted draw storage tank 17 via the supernatant water tank 16, the heat exchanger 22, and the cross valve 33 to be mixed with the draw solution, and is further circulated to the separation tank 13 via the heat exchanger 22 and the heater 12.

In the circulating and heating process described above, the high-temperature draw solution having a temperature equal to or higher than the cloud point, for example, 88° C., is supplied to the diluted draw storage tank 17 from the separation tank 13. Due to this, in the diluted draw storage tank 17, the temperature of the stored draw solution is raised. Additionally, the temperature of the water-rich solution having a temperature equal to or higher than the cloud point, for example, 88° C., that has been supplied from the separation tank 13 via the supernatant water tank 16 is lowered to a temperature of about 45° C., for example, by the heat exchanger 22, and the water-rich solution is supplied to the diluted draw storage tank 17 thereafter. Due to this, the temperature of the draw solution in the diluted draw storage tank 17 is further raised. That is, the temperature of the draw solution in the diluted draw storage tank 17 is raised by the draw solution flowed out from the separation tank 13, and the water-rich solution that has flowed out from the separation tank 13 and passed through the heat exchanger 22. That is, thermal energy in the separation tank 13 is used for raising the temperature of the draw solution in the diluted draw storage tank 17, so that, at the beginning, the temperature of the draw solution in the separation tank 13 may be temporarily lowered by the draw solution having an environment temperature that has been put into the diluted draw storage tank 17 in advance. Specifically, for example, the temperature of the draw solution in the separation tank 13 may be lowered to about 60° C. Also in this case, by continuing the circulating and heating process, the temperature of the draw solution in the separation tank 13 and in the diluted draw storage tank 17 can be raised with thermal energy supplied to the heater 12. Although a load on the heater 12 is increased, by enhancing heating performed by the heater 12 as needed, the draw solution supplied to the separation tank 13 can be heated to a temperature equal to or higher than the cloud point, for example, 88° C., at all times.

The circulating and heating process described above is continued, and after the temperature of the draw solution in the separation tank 13 is raised to a temperature equal to or higher than the cloud point, for example, about 88° C., and the temperature of the draw solution in the diluted draw storage tank 17 is raised to a predetermined temperature, for example, equal to or higher than 40° C., the cross valves 32 and 33 are switched. Due to this, the draw solution supplied from the separation tank 13 is supplied to the heat exchanger 21 via the cross valve 32, and supplied to the membrane module 11 as a recycled draw solution thereafter. Additionally, when the water-containing solution is supplied to the membrane module 11, the forward osmosis process is started in the membrane module 11. On the other hand, when the water-rich solution flowed out from the separation tank 13 flows into the supernatant water tank 16, and passes through the heat exchanger 22 to be supplied to the final treatment unit 14, final treatment is started. Accordingly, the water treatment apparatus 8 is started, and water treatment in the steady state according to the seventh embodiment described above is started. The recycled draw solution and the water-containing solution may be supplied to the membrane module 11 at the same time, or any one thereof may be supplied earlier. Supply of the recycled draw solution to the membrane module 11, and supply of the water-rich solution to the final treatment unit 14 and starting of the final treatment unit 14 may be performed at the same time, or any one thereof may be performed earlier.

According to the seventh embodiment, by raising the temperature of the draw solution in the separation tank 13 to a temperature equal to or higher than the cloud point in the preceding stage starting process, an effect similar to that of the sixth embodiment can be obtained. When the water treatment apparatus 8 is started without performing preliminary heating in the succeeding stage starting process described above, a heating load is increased at an initial stage, so that the size of the heater 12 needs to be greatly increased. In this case, used is a heat exchanger having an excessively large size for the water treatment method in the steady state, so that heating in water treatment in the steady state becomes unstable, and equipment cost at an initial stage is increased. On the other hand, in the seventh embodiment described above, in a case of disposing the diluted draw storage tank 17, the draw solution in the diluted draw storage tank 17 is also preliminarily heated in the succeeding stage starting process. Due to this, the water treatment apparatus 8 is enabled to be stably started, and temperature balance in the system of the water treatment apparatus 8 can be rapidly stabilized.

### Eighth Embodiment

### Water Treatment Apparatus

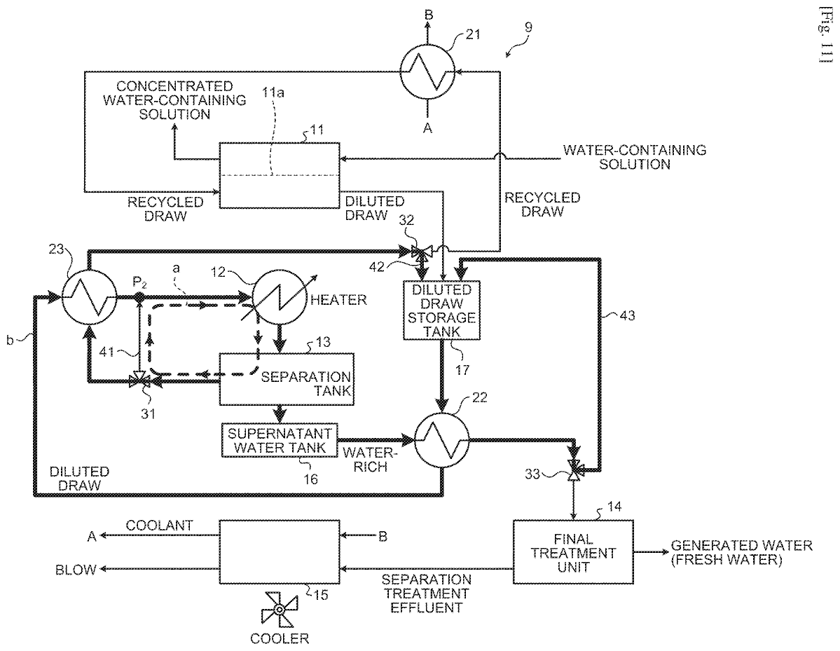

Next, the following describes an eighth embodiment. FIG. 11 illustrates a water treatment apparatus 9 according to the eighth embodiment. As illustrated in FIG. 11, the water treatment apparatus 9 includes the membrane module 11 including the semipermeable membrane 11a disposed therein, the heater 12, the separation tank 13, the final treatment unit 14, the cooling mechanism 15, the supernatant water tank 16, the diluted draw storage tank 17, the cross valves 31, 32, and 33, and the heat exchangers 21 and 22 similarly to the seventh embodiment. A different point from the seventh embodiment is that the water treatment apparatus 9 further includes the heat exchanger 23 as a succeeding stage heat exchange unit. The heat exchanger 23 is disposed on the downstream side of the heat exchanger 22 and the upstream side of the heater 12 along the flowing direction of the diluted draw solution, and on the downstream side of the separation tank 13 and the upstream side of the heat exchanger 21 along the flowing direction of the recycled draw solution.

### Water Treatment Method in Steady State

Next, the following describes a water treatment method in the steady state according to the eighth embodiment performed by the water treatment apparatus 9 configured as described above. That is, in the water treatment method according to the eighth embodiment, the heat exchanger 23 performs the succeeding stage heat exchange process. Specifically, the diluted draw solution flowed out from the membrane module 11 flows into the diluted draw storage tank 17, and is supplied to the heat exchanger 22 to be heat-exchanged with the high-temperature water-rich solution. Subsequently, as the succeeding stage heat exchange process, the diluted draw solution is heat-exchanged with the recycled draw solution having substantially the same temperature as the water-rich solution by the heat exchanger 23, and the temperature of the diluted draw solution is raised. Thereafter, the diluted draw solution is heated to a temperature equal to or higher than the cloud point and equal to or lower than 100° C. by the heater 12, and supplied to the separation tank 13. Other processes of the water treatment method in the steady state are the same as those in the seventh embodiment.

### Method of Starting Water Treatment Apparatus

### Preparing Process and Preceding Stage Starting Process

Next, the following describes a method of starting the water treatment apparatus 9 according to the eighth embodiment. In the eighth embodiment, the preparing process and the preceding stage starting process are performed similarly to the seventh embodiment. That is, in the preceding stage starting process, as indicated by the bold dashed line a in FIG. 11, the draw solution in the separation tank 13 is caused to pass through the circulation flow passage 41 to be heated by the heater 12, and is circulated to the separation tank 13. Due to this, the temperature of the draw solution in the separation tank 13 is raised from an environment temperature to a temperature equal to or higher than the cloud point.

### Succeeding Stage Starting Process

Additionally, in the eighth embodiment, the succeeding stage starting process is performed similarly to the seventh embodiment. That is, after the draw solution having an environment temperature is put into the diluted draw storage tank 17, the temperature of the draw solution is raised.

### Switching Process

Specifically, first, the cross valves 32 and 33 perform the switching process. That is, the cross valve 32 is switched so that the draw solution that has flowed out from the separation tank 13 and passed through the cross valve 31 and the heat exchanger 23 is allowed to flow into the diluted draw storage tank 17 through the cross valve 32. On the other hand, the cross valve 33 is switched so that the water-rich solution flowed out from the separation tank 13 is allowed to flow into the diluted draw storage tank 17 through the cross valve 33 via the supernatant water tank 16 and the heat exchanger 22.

### Circulating and Heating Process

Next, the circulating and heating process is performed by the heater 12, the separation tank 13, the supernatant water tank 16, the diluted draw storage tank 17, and the heat exchangers 22 and 23. In FIG. 11, a flow passage of the draw solution and the water-rich solution in the circulating and heating process is denoted by the bold solid line b.

That is, when the cross valve 31 is switched, the draw solution in the separation tank 13 that has been heated in the preceding stage starting process flows out from the separation tank 13, and is supplied to the diluted draw storage tank 17 through the cross valve 32 and the upstream side bypass flow passage 42. In the diluted draw storage tank 17, the draw solution stored in advance, the draw solution that has flowed in from the separation tank 13 through the upstream side bypass flow passage 42, and the water-rich solution that has flowed in from the supernatant water tank 16 through the downstream side bypass flow passage 43 (described later) are mixed with each other. The temperature of the draw solution in the diluted draw storage tank 17 is raised from an environment temperature of about 25° C., for example. The water-rich solution flowed into the diluted draw storage tank 17 is mixed with the stored draw solution. The temperature of the draw solution in the diluted draw storage tank 17 is raised when the high-temperature draw solution and the high-temperature water-rich solution flows therein.

The draw solution the temperature of which is raised in the diluted draw storage tank 17 is supplied to the heat exchanger 22 by a water supply pump (not illustrated), for example, and heat-exchanged with the high-temperature water-rich solution flowed out from the separation tank 13, the high-temperature water-rich solution having a temperature equal to or higher than the cloud point, for example, about 88° C. The draw solution the temperature of which is raised by the heat exchanger 22 is supplied to the heat exchanger 23, and a succeeding stage temperature raising process is performed. That is, the draw solution the temperature of which is raised by the heat exchanger 22 is heat-exchanged with the high-temperature draw solution flowed out from the separation tank 13 by the heat exchanger 23, and the temperature of the draw solution is further raised. The draw solution the temperature of which is raised after passing through the heat exchanger 23 is supplied to the heater 12. In the heater 12, the draw solution is further heated to a temperature equal to or higher than the cloud point and equal to or lower than the boiling point. The heated draw solution is supplied to the separation tank 13. That is, the draw solution flowed out from the separation tank 13 successively passes through the cross valve 31, the heat exchanger 23, the cross valve 32, the diluted draw storage tank 17, the heat exchangers 22 and 23, and the heater 12 to be circulated to the separation tank 13.

On the other hand, the high-temperature water-rich solution having a temperature equal to or higher than the cloud point flowed out from the separation tank 13 flows into the supernatant water tank 16 to be stored therein. Thereafter, the water-rich solution is supplied to the heat exchanger 22 by a water supply pump (not illustrated), for example, is heat-exchanged with the low-temperature draw solution supplied from the diluted draw storage tank 17, and the temperature of the water-rich solution is lowered. The water-rich solution the temperature of which is lowered by the heat exchanger 22 is allowed to flow into the diluted draw storage tank 17 by the cross valve 33 through the downstream side bypass flow passage 43. The water-rich solution flowed into the diluted draw storage tank 17 is mixed with the stored draw solution. Thereafter, the draw solution in the diluted draw storage tank 17 is supplied to the separation tank 13 through the flow passage on the downstream side of the diluted draw storage tank 17 described above. That is, the water-rich solution flowed out from the separation tank 13 is supplied to the diluted draw storage tank 17 to be mixed with the draw solution via the supernatant water tank 16, the heat exchanger 22, and the cross valve 33, and successively passes through the heat exchangers 22 and 23 and the heater 12 to be circulated to the separation tank 13.

In the circulating and heating process described above, the high-temperature draw solution flowed out from the separation tank 13 is supplied to the diluted draw storage tank 17, the high-temperature draw solution having a temperature of about 35 to 60° C., for example, which is lowered by the heat exchanger 23. Even if the temperature of the draw solution is lowered by the heat exchanger 23, the temperature of the draw solution is higher than that of the draw solution in the diluted draw storage tank 17, so that the temperature of the draw solution stored in the diluted draw storage tank 17 is raised to a temperature higher than the environment temperature. Additionally, the temperature of the water-rich solution having a temperature equal to or higher than the cloud point supplied from the separation tank 13 via the supernatant water tank 16 is lowered to a temperature of about 30 to 60° C., for example, about 45° C., by the heat exchanger 22, and the water-rich solution is supplied to the diluted draw storage tank 17 thereafter. Due to this, the temperature of the draw solution in the diluted draw storage tank 17 is further raised to a temperature equal to or higher than an environment temperature. That is, the temperature of the draw solution in the diluted draw storage tank 17 is raised by the draw solution that has flowed out from the separation tank 13 and passed through the heat exchanger 23, and the water-rich solution that has flowed out from the separation tank 13 and passed through the heat exchanger 22. Due to this, thermal energy in the separation tank 13 is used for raising the temperature of the draw solution in the diluted draw storage tank 17, so that, at the beginning, the temperature of the draw solution in the separation tank 13 may be temporarily lowered by the draw solution having an environment temperature that has been put into the diluted draw storage tank 17 in advance. Specifically, for example, the temperature of the draw solution in the separation tank 13 may be lowered to about 50 to 85° C., for example, about 60° C. Also in this case, by continuing the circulating and heating process, the temperature of the draw solution in the separation tank 13 and in the diluted draw storage tank 17 can be raised by continuously supplying thermal energy from the heater 12 to the draw solution. Although a load on the heater 12 is increased, by enhancing heating performed by the heater 12 as needed, the draw solution supplied to the separation tank 13 can be heated to a temperature equal to or higher than the cloud point and equal to or lower than the boiling point, for example, 88° C., at all times.

The circulating and heating process described above is continued, and after the temperature of the draw solution in the separation tank 13 is raised to a temperature equal to or higher than the cloud point, for example, about 88° C., and the temperature of the draw solution in the diluted draw storage tank 17 is raised to a predetermined temperature, for example, equal to or higher than 40° C., the cross valves 32 and 33 are switched. Due to this, the draw solution flowed out from the separation tank 13 successively passes through the heat exchanger 23 and the cross valve 32 to be supplied to the heat exchanger 21, and is supplied to the membrane module 11 as a recycled draw solution. Additionally, when the water-containing solution is supplied to the membrane module 11, the forward osmosis process is started by the membrane module 11. On the other hand, when the water-rich solution flowed out from the separation tank 13 flows into the supernatant water tank 16, and successively passes through the heat exchanger 22 and the cross valve 33 to be supplied to the final treatment unit 14, final treatment is started. Due to this, the water treatment apparatus 9 is started, and water treatment in the steady state according to the eighth embodiment described above is started. The recycled draw solution and the water-containing solution may be supplied to the membrane module 11 at the same time, or any one thereof may be supplied earlier. Supply of the recycled draw solution to the membrane module 11, and supply of the water-rich solution to the final treatment unit 14 and starting of the final treatment unit 14 may be performed at the same time, or any one thereof may be performed earlier.

According to the eighth embodiment, by raising the temperature of the draw solution in the separation tank 13 to a temperature equal to or higher than the cloud point in the preceding stage starting process, an effect similar to that of the sixth embodiment can be obtained. Additionally, the temperature of the draw solution in the diluted draw storage tank 17 is raised to a predetermined temperature in the succeeding stage starting process, so that an effect similar to that of the seventh embodiment can be obtained. When the water treatment apparatus 9 is started without performing preliminary heating in the succeeding stage starting process described above, an operation is started in a non-steady state of heating and cooling. Thus, heat balance in the system is more easily lost as compared with the water treatment apparatus 8 according to the seventh embodiment due to the heat exchanger 23, and the operation of the water treatment apparatus 9 may be stopped. On the other hand, in the eighth embodiment, preliminary heating is performed on the draw solution in the diluted draw storage tank 17 in the succeeding stage starting process. Due to this, even in a case of disposing the heat exchanger 23, the water treatment apparatus 9 is enabled to be stably started, and temperature balance in the system of the water treatment apparatus 9 can be rapidly stabilized.

### Ninth Embodiment

### Water Treatment Apparatus

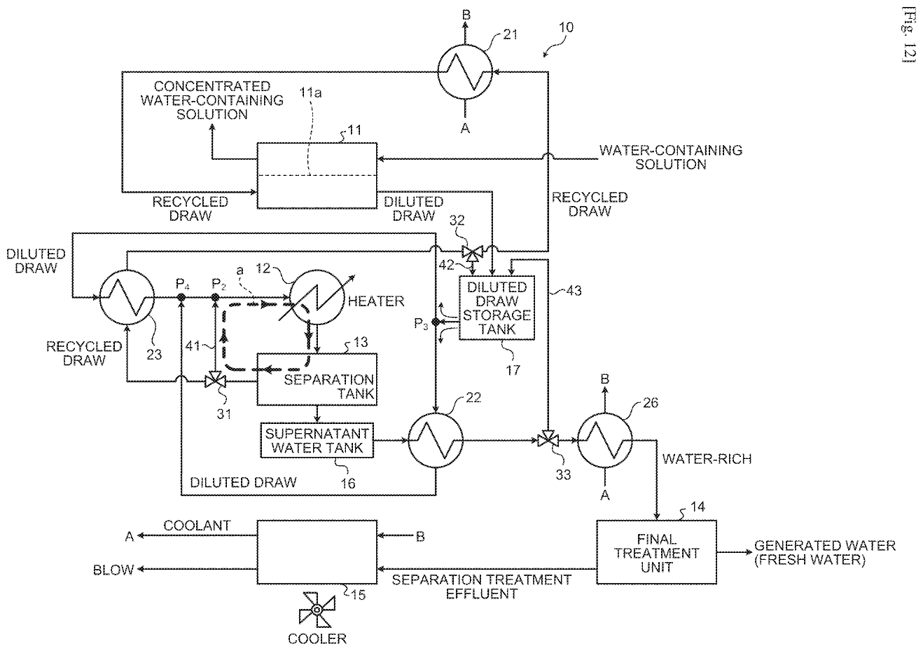

Next, the following describes a ninth embodiment. FIG. 12 illustrates a water treatment apparatus 10 according to the ninth embodiment. As illustrated in FIG. 12, the water treatment apparatus 10 includes the membrane module 11 including the semipermeable membrane 11a disposed therein, the heater 12, the separation tank 13, the final treatment unit 14, the cooling mechanism 15, the supernatant water tank 16, the diluted draw storage tank 17, the heat exchangers 21, 22, and 23, and the cross valves 31, 32, and 33 similarly to the eighth embodiment. A different point from the eighth embodiment is that the water treatment apparatus 10 further includes the heat exchanger 26 as a heat exchange unit before final treatment on the downstream side of the heat exchanger 22 and the cross valve 33 and the upstream side of the final treatment unit 14 along the flowing direction of the water-rich solution. The heat exchanger 26 performs heat exchange between the coolant supplied from the cooling mechanism 15 and the water-rich solution passed through the heat exchanger 22, and supplies the water-rich solution to the final treatment unit 14.

In the water treatment apparatus 10, a diverging point P₃ is disposed in the flow passage on the downstream side of the diluted draw storage tank 17 along the flowing direction of the diluted draw solution. At the diverging point P₃, the diluted draw solution is caused to diverge into at least two directions. One of diverged flow passages communicates with the heat exchanger 22, and the other one thereof communicates with the heat exchanger 23. Additionally, a converging point P₄ is disposed in the flow passage on the upstream side of the heater 12 along the flowing direction of the diluted draw solution, the converging point P₄ at which the diluted draw solution passed through the heat exchanger 22 and the diluted draw solution passed through the heat exchanger 23 converge. At the converging point P₄, the diluted draw solutions diverged at the diverging point P₃ converge. That is, each of the heat exchangers 22 and 23 as a parallel heat exchange unit is configured to be able to perform heat exchange between the diluted draw solution, and the other recycled draw solution and water-rich solution. In FIG. 12, the converging point P₄ is disposed on the upstream side of the inflow point P₂ in the circulation flow passage 41, but the converging point P₄ may be disposed on the downstream side of the inflow point P₂.

### Water Treatment Method in Steady State

Next, the following describes a water treatment method in the steady state according to the ninth embodiment performed by the water treatment apparatus 10 configured as described above. That is, in the water treatment method according to the ninth embodiment, the heat exchangers 22 and 23 as parallel heat exchange units perform a parallel heat exchange process. Specifically, the diluted draw solution flowed out from the membrane module 11 flows into the diluted draw storage tank 17, and is caused to diverge at the diverging point P₃ in the flow passage from the diluted draw storage tank 17 toward the upstream side of the heat exchangers 22 and 23. The diluted draw solution supplied to the heat exchanger 22 through one of diverged flow passages is heat-exchanged with the high-temperature water-rich solution, and the temperature of the diluted draw solution is raised. The diluted draw solution supplied to the heat exchanger 23 through the other one of the diverged flow passages is heat-exchanged with the recycled draw solution having substantially the same temperature as the water-rich solution, and the temperature of the diluted draw solution is raised. In other words, after the diluted draw solution flowed out from the membrane module 11 flows into the diluted draw storage tank 17, and is caused to diverge at the diverging point P₃, the diverged diluted draw solutions pass through the heat exchangers 22 and 23 in parallel to be heat-exchanged with the water-rich solution and the recycled draw solution, respectively, as the parallel heat exchange process. Due to this, the flow rate of the diluted draw solution the temperature of which is raised by the recycled draw solution and the flow rate of the diluted draw solution the temperature of which is raised by the water-rich solution can be reduced as compared with the eighth embodiment, and the temperature width of the temperature to be raised can be widened.

The water treatment apparatus 10 is configured such that the diluted draw solutions diverged at the diverging point P₃ can converge at the converging point P₄ on the downstream side of each of the heat exchangers 22 and 23 and the upstream side of the heater 12. That is, the diluted draw solutions that have passed through the heat exchangers 22 and 23 to be heat-exchanged in parallel converge at the converging point P₄. In this case, a flow rate ratio between one of the diluted draw solutions supplied to the heat exchanger 22 as one heat exchange unit and the other one of the diluted draw solutions supplied to the heat exchanger 23 as the other heat exchange unit is adjusted by an adjusting valve (not illustrated) disposed in the vicinity of the diverging point P₃. The flow rate ratio at the diverging point P₃ adjusted by the adjusting valve is adjusted so that the temperature of one of the diluted draw solutions is substantially equal to the temperature of the other one of the diluted draw solutions at the converging point P₄. The diluted draw solution converged at the converging point P₄ is heated to a temperature equal to or higher than the cloud point and equal to or lower than the boiling point by the heater 12.

The heat exchanger 26 as a heat exchange unit before final treatment performs the heat exchange process before final treatment. That is, the high-temperature water-rich solution of about 88° C. flowed out from the separation tank 13 and stored in the supernatant water tank 16 is supplied to the heat exchanger 22, and the temperature thereof is lowered to a temperature equal to or higher than 30° C. and equal to or lower than 50° C., for example, 45° C. Thereafter, as the heat exchange process before final treatment, the temperature of the water-rich solution that has passed through the heat exchanger 22 and the cross valve 33 is lowered to a temperature equal to or higher than 30° C. and equal to or lower than 45° C., for example, 35° C., by the heat exchanger 26, and the water-rich solution is then supplied to the final treatment unit 14. Other processes of the water treatment method in the steady state are the same as those in the eighth embodiment.

### Method of Starting Water Treatment Apparatus

### Preceding Stage Starting Process

Next, the following describes a method of starting the water treatment apparatus 10 according to the ninth embodiment. That is, in the ninth embodiment, the preparing process is firstly performed, and the preceding stage starting process is performed thereafter similarly to the seventh and the eighth embodiments. In the preceding stage starting process, as denoted by the bold dashed line a in FIG. 12, the draw solution in the separation tank 13 is supplied to the heater 12 to be heated through the cross valve 31 and the circulation flow passage 41, and is circulated to the separation tank 13. Due to this, the temperature of the draw solution in the separation tank 13 is raised from an environment temperature to a temperature equal to or higher than the cloud point.

### Succeeding Stage Starting Process

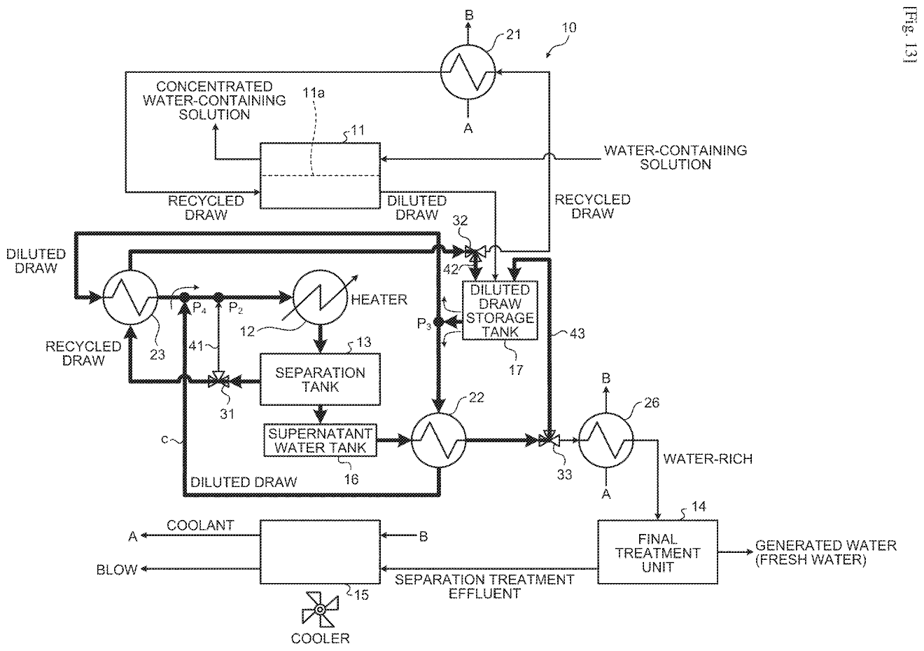

Thereafter, the succeeding stage starting process is performed. FIG. 13 is a block diagram schematically illustrating the succeeding stage starting process performed by the water treatment apparatus 10 according to the ninth embodiment. In FIG. 13, a flow passage of the draw solution and the water-rich solution in the circulating and heating process is denoted by a bold solid line c. First, similarly to the seventh and the eighth embodiments, the draw solution containing the temperature sensitive absorbent and water having an environment temperature is put into the diluted draw storage tank 17, and the draw solution having polymer concentration of about 50%, for example, is stored therein. The draw solution may be put into the diluted draw storage tank 17 before or after the preparing process described above, or before or after the preceding stage starting process.

### Switching Process

Next, as illustrated in FIG. 13, the cross valves 32 and 33 perform the switching process. That is, the cross valve 32 is switched so that the draw solution that has flowed out from the separation tank 13 and passed through the cross valve 31 and the heat exchanger 23 is enabled to flow into the diluted draw storage tank 17 through the cross valve 32. On the other hand, the cross valve 33 is switched so that the water-rich solution flowed out from the separation tank 13 is enabled to flow into the diluted draw storage tank 17 through the cross valve 33 via the supernatant water tank 16 and the heat exchanger 22.

### Circulating and Heating Process

Next, the circulating and heating process is performed by the heater 12, the separation tank 13, the supernatant water tank 16, the diluted draw storage tank 17, and the heat exchangers 22 and 23. That is, the high-temperature draw solution heated in the preceding stage starting process by switching the cross valve 31 flows out from the separation tank 13, and is supplied to the diluted draw storage tank 17 through the cross valve 31, the heat exchanger 23, the cross valve 32, and the upstream side bypass flow passage 42. On the other hand, as described later, the high-temperature water-rich solution having a temperature equal to or higher than the cloud point flowed out from the separation tank 13 flows into the supernatant water tank 16 to be stored therein. Thereafter, the water-rich solution is supplied to the heat exchanger 22 by a water supply pump (not illustrated), for example, is heat-exchanged with the low-temperature draw solution supplied from the diluted draw storage tank 17, and the temperature of the water-rich solution is lowered. The water-rich solution the temperature of which is lowered by the heat exchanger 22 is allowed to flow into the diluted draw storage tank 17 through the downstream side bypass flow passage 43 by the cross valve 33.

In the diluted draw storage tank 17, the draw solution stored in advance, the draw solution that has flowed in from the separation tank 13 through the upstream side bypass flow passage 42, and the water-rich solution that has flowed in from the supernatant water tank 16 through the downstream side bypass flow passage 43 are mixed with each other. The temperature of the draw solution in the diluted draw storage tank 17 is raised from an environment temperature of about 25° C., for example. The water-rich solution flowed into the diluted draw storage tank 17 is mixed with the stored draw solution. The temperature of the draw solution in the diluted draw storage tank 17 is raised when the high-temperature draw solution and the high-temperature water-rich solution flow thereinto.

The draw solution stored in the diluted draw storage tank 17 is allowed to flow out by a water supply pump (not illustrated), for example, and caused to diverge at the diverging point P₃. The draw solution flowing in one of diverged flow passages on the heat exchanger 22 side is heat-exchanged, by the heat exchanger 22, with the high-temperature water-rich solution having a temperature equal to or higher than the cloud point supplied from the separation tank 13 via the supernatant water tank 16, and the temperature of the draw solution is raised. The draw solution flowing in the other one of the diverged flow passages on the heat exchanger 23 side is heat-exchanged, by the heat exchanger 23, with the high-temperature draw solution having a temperature equal to or higher than the cloud point flowed out from the separation tank 13, and the temperature of the draw solution is raised. In other words, after the draw solution flowed out from the diluted draw storage tank 17 is caused to diverge at the diverging point P₃, the diverged draw solutions pass through the heat exchangers 22 and 23 in parallel, and are heat-exchanged with the high-temperature water-rich solution and the draw solution each having a temperature equal to or higher than the cloud point, respectively.

The draw solutions passed through the heat exchangers 22 and 23 in parallel converge at the converging point P₄ on the downstream side of the heat exchangers 22 and 23 and the upstream side of the heater 12. A flow rate ratio between the draw solution flowing in one of the flow passages diverged at the diverging point P₃ described above and the draw solution flowing in the other one of the flow passages is adjusted by an adjusting valve (not illustrated) disposed in the vicinity of the diverging point P₃. Specifically, the flow rate ratio of the draw solutions at the diverging point P₃ is adjusted by the adjusting valve so that the temperature of one of the draw solutions is substantially equal to the temperature of the other one of the draw solutions at the converging point P₄. The draw solution converged at the converging point P₄ is supplied to the heater 12, and further heated to a temperature equal to or higher than the cloud point and equal to or lower than the boiling point. The heated draw solution is supplied to the separation tank 13. That is, the draw solutions flowed out from the separation tank 13 successively pass through the cross valve 31, the heat exchanger 23, the cross valve 32, and the diluted draw storage tank 17, pass through the heat exchangers 22 and 23 in parallel, and converge. Thereafter, the converged draw solution is supplied to the heater 12, and circulated to the separation tank 13. On the other hand, the water-rich solution flowed out from the separation tank 13 is supplied to the diluted draw storage tank 17 via the supernatant water tank 16, the heat exchanger 22, and the cross valve 33, is mixed with the draw solution, and successively passes through the heat exchangers 22 and 23 and the heater 12 to be circulated to the separation tank 13. Other processes of the starting method are the same as those of the eighth embodiment.

In the circulating and heating process described above, the temperature of the draw solution in the diluted draw storage tank 17 is raised by the draw solution that has flowed out from the separation tank 13 and passed through the heat exchanger 23, and the water-rich solution that has flowed out from the separation tank 13 and passed through the heat exchanger 22 via the supernatant water tank 16. Due to this, an effect similar to that of the circulating and heating process according to the eighth embodiment can be obtained.

The circulating and heating process described above is continued, and after the temperature of the draw solution in the separation tank 13 is raised to a temperature equal to or higher than the cloud point, for example, about 88° C., and the temperature of the draw solution in the diluted draw storage tank 17 is raised to a predetermined temperature, for example, equal to or higher than 40° C., the cross valves 32 and 33 are switched. Due to this, after the draw solution flowed out from the separation tank 13 successively passes through the heat exchanger 23 and the cross valve 32 to be supplied to the heat exchanger 21, the draw solution is supplied to the membrane module 11 as a recycled draw solution, and the water-containing solution is further supplied to the membrane module 11 to start the forward osmosis process by the membrane module 11. On the other hand, after being stored in the supernatant water tank 16, the water-rich solution flowed out from the separation tank 13 successively passes through the heat exchanger 22, the cross valve 33, and the heat exchanger 26 to be supplied to the final treatment unit 14, and the final treatment is started. Due to this, the water treatment apparatus 10 is started, and water treatment in the steady state according to the ninth embodiment described above is started. The recycled draw solution and the water-containing solution may be supplied to the membrane module 11 at the same time, or any one thereof may be supplied earlier. Supply of the recycled draw solution to the membrane module 11, and supply of the water-rich solution to the final treatment unit 14 and starting of the final treatment unit 14 may be performed at the same time, or any one thereof may be started earlier.

According to the ninth embodiment, by raising the temperature of the draw solution in the separation tank 13 to a temperature equal to or higher than the cloud point in the preceding stage starting process, an effect similar to that of the sixth embodiment can be obtained. Additionally, the temperature of the draw solution in the diluted draw storage tank 17 is raised to a predetermined temperature at the time of starting the water treatment apparatus 10, so that an effect similar to that of the seventh and the eighth embodiments can be obtained.

In the water treatment method in the steady state according to the ninth embodiment, the diluted draw solution flowed out from the membrane module 11 is caused to diverge to be heat-exchanged with the water-rich solution by the heat exchanger 22 and be heat-exchanged with the recycled draw solution by the heat exchanger 23 to raise the temperatures of the diverged diluted draw solutions in parallel. Due to this, the temperature of the diluted draw solution can be caused to be higher than that in the seventh and the eighth embodiments on the upstream side of the heater 12, so that the temperature width of the temperature raised in heating the diluted draw solution by the heater 12 can be further narrowed as compared with the seventh and the eighth embodiments. Thus, the energy required for heating performed by the heater 12 can be further reduced, and the energy consumed in heating in the water treatment apparatus 10 can be further reduced.

With the water treatment apparatuses 6 to 10 according to the sixth to the ninth embodiments and starting methods thereof, a starting time until reaching the steady state can be shortened while stably starting the water treatment apparatus that causes fresh water from the water-containing solution to permeate the draw solution.

The embodiments have been specifically described above. However, the present disclosure is not limited to the embodiments described above, and can be variously modified based on a technical idea of the present disclosure. For example, numerical values and components in the embodiments described above are merely examples, and different numerical values or components may be used as needed. The present disclosure is not limited to the description and the drawings as part of the disclosure of the present disclosure according to the embodiments.

For example, the second embodiment and the third embodiment described above can be implemented at the same time. That is, the heat exchanger 24 for performing heat exchange between the recycled draw solution and the diluted draw solution may be disposed on the downstream side or the upstream side of the heat exchanger 23 to perform the preceding stage heat exchange process and the succeeding stage heat exchange process at the same time.

For example, in the first to the fifth embodiments described above, the flow rate of water moved in the membrane module 11 is assumed to be 385 L/h, the flow rate of the generated water that is finally obtained is assumed to be 300 L/h, and a recovery rate is assumed to be 78%. However, the recovery rate is not limited thereto, and can be optionally set.

For example, the heat exchanger 26 as a heat exchange unit before final treatment according to the fifth and the ninth embodiments described above can be applied to the water treatment apparatuses 1 to 3 according to the first to the third embodiments and the water treatment apparatuses 6 to 9 according to the sixth to the eighth embodiments.

In the water treatment apparatuses 1 to 10 according to the first to the ninth embodiments described above, a refractometer may be disposed on the downstream side of the heat exchanger 21 and the upstream side of the membrane module 11 along the flowing direction of the recycled draw solution. Due to this, the polymer concentration of the recycled draw solution can be measured.

### INDUSTRIAL APPLICABILITY

The water treatment apparatus, the water treatment method, and the method of starting the water treatment apparatus can be preferably used for a water treatment system for extracting water from a water-containing solution containing water as a solvent.

### REFERENCE SIGNS LIST

1, 2, 3, 4, 5, 6, 7, 8, 9, 10 WATER TREATMENT APPARATUS
11 MEMBRANE MODULE
11a SEMIPERMEABLE MEMBRANE
12 HEATER
13 SEPARATION TANK
14 FINAL TREATMENT UNIT
15 COOLING MECHANISM
16 SUPERNATANT WATER TANK
17 DILUTED DRAW STORAGE TANK
21, 22, 23, 24, 25, 26 HEAT EXCHANGER
31, 32, 33 CROSS VALVE
41 CIRCULATION FLOW PASSAGE
42 UPSTREAM SIDE BYPASS FLOW PASSAGE
43 DOWNSTREAM SIDE BYPASS FLOW PASSAGE

1. A water treatment apparatus comprising:
a forward osmosis device configured to allow a diluted draw solution to flow out, the diluted draw solution being obtained by causing water to move to a draw solution having a cloud point from a water-containing solution containing water as a solvent via a semipermeable membrane to dilute the draw solution, and configured to discharge the water-containing solution as a concentrated water-containing solution that is concentrated;
a heater configured to heat the diluted draw solution to a temperature equal to or higher than the cloud point;
a water separator configured to separate the diluted draw solution heated by the heater into a water-rich solution and the draw solution having water content lower than that of the water-rich solution;
a cooler configured to cool a liquid and allow the liquid to flow out as a coolant;
an inflow side heat exchanger configured to perform heat exchange between the coolant flowed out from the cooler and the draw solution flowed out from the water separator; and
an outflow side heat exchanger configured to perform heat exchange between the diluted draw solution flowed out from the forward osmosis device and the water-rich solution flowed out from the water separator.

2. The water treatment apparatus according to claim 1, further comprising a separation treatment device configured to obtain generated water from the water-rich solution.

3. The water treatment apparatus according to claim 2, further comprising a heat exchanger before final treatment disposed on a downstream side of the outflow side heat exchanger and an upstream side of the separation treatment device along a flowing direction of the water-rich solution, the heat exchanger before final treatment configured to perform heat exchange between the water-rich solution flowed out from the water separator and the coolant flowed out from the cooler.

4. The water treatment apparatus according to claim 2, wherein the separation treatment device is configured to supply, to the cooler, separation treatment effluent separated from the generated water.

5. The water treatment apparatus according to claim 1, further comprising a succeeding stage heat exchanger configured to perform heat exchange between the draw solution flowed out from the water separator and the diluted draw solution flowed out from the forward osmosis device.

6. The water treatment apparatus according to claim 1, further comprising a preceding stage heat exchanger disposed on an upstream side of the outflow side heat exchanger along a flowing direction of the diluted draw solution, the preceding stage heat exchanger configured to perform heat exchange between the draw solution flowed out from the water separator and the diluted draw solution flowed out from the forward osmosis device.

7. The water treatment apparatus according to claim 1, the water treatment apparatus is configured to circulate the coolant between the cooler and the inflow side heat exchanger.

8. The water treatment apparatus according to claim 1, the water treatment apparatus is configured to cause the diluted draw solution flowed out from the forward osmosis device to diverge to be heat-exchanged by a parallel heat exchanger in which at least two heat exchangers are arranged in parallel, and configured to cause diverged diluted draw solutions heat-exchanged by the parallel heat exchanger to converge on an upstream side of the heater.

9. The water treatment apparatus according to claim 8, wherein the parallel heat exchanger is configured such that one of the diverged diluted draw solutions is heat-exchanged with the water-rich solution flowed out from the water separator, and the other one of the diverged diluted draw solutions is heat-exchanged with the draw solution flowed out from the water separator.

10. The water treatment apparatus according to claim 1, further comprising a circulation flow passage configured to cause a downstream side of the water separator and an upstream side of the forward osmosis device along a flowing direction of the draw solution to communicate with an upstream side of the heater and a downstream side of the forward osmosis device along a flowing direction of the diluted draw solution.

11. The water treatment apparatus according to claim 10, further comprising
a diluted draw storage configured to store the diluted draw solution flowed out from the forward osmosis device, and
an upstream side bypass flow passage configured to cause the diluted draw storage to communicate with a downstream side of the water separator and an upstream side of the forward osmosis device along a flowing direction of the draw solution.

12. The water treatment apparatus according to claim 10, further comprising
a diluted draw storage configured to store the diluted draw solution flowed out from the forward osmosis device, and
a downstream side bypass flow passage configured to cause the diluted draw storage to communicate with a downstream side of the water separator along a flowing direction of the water-rich solution.

13. A water treatment method comprising:
allowing a diluted draw solution to flow out, the diluted draw solution being obtained by causing water to move to a draw solution having a cloud point from a water-containing solution containing water as a solvent via a semipermeable membrane to dilute the draw solution, and discharge the water-containing solution as a concentrated water-containing solution that is concentrated;
heating the diluted draw solution to a temperature equal to or higher than the cloud point;
separating the heated diluted draw solution into a water-rich solution and the draw solution having water content lower than that of the water-rich solution;
cooling a liquid to generate a coolant;
performing heat exchange between the coolant and the draw solution having water content lower than that of the water-rich solution; and
performing heat exchange between the diluted draw solution and the water-rich solution.

14. The water treatment method according to claim 13, further comprising obtaining generated water from the water-rich solution.

15. The water treatment method according to claim 14, further comprising performing heat exchange between the water-rich solution and the coolant before obtaining the generated water from the water-rich solution.

16. The water treatment method according to claim 14, wherein separation treatment effluent, separated from the generated water when obtaining the generated water from the water-rich solution, is used as the liquid to generate the coolant.

17. The water treatment method according to claim 13, further comprising performing heat exchange between the diluted draw solution the draw solution having water content lower than that of the water-rich solution, before performing heat exchange between the diluted draw solution and the water-rich solution.

18. The water treatment method according to claim 13, further comprising performing heat exchange between the draw solution and the diluted draw solution that is heat-exchanged with the water-rich solution.

19. The water treatment method according to claim 13, wherein the coolant, after being heat-exchanged with the draw solution having water content lower than that of the water-rich solution, is cooled as the liquid to generate the coolant.

20. The water treatment method according to claim 13, further comprising:
diverging the diluted draw solution and performing heat exchange between diverged diluted draw solutions by at least two heat exchangers in parallel; and
converging the diverged diluted draw solutions before the heating.

21. The water treatment method according to claim 20, wherein
one of the diverged diluted draw solutions is heat-exchanged with the water-rich solution, and the other one of the diverged diluted draw solutions is heat-exchanged with the draw solution having water content lower than that of the water-rich solution.

22. A method of starting a water treatment apparatus, the water treatment apparatus including:
a forward osmosis device configured to allow a diluted draw solution to flow out, the diluted draw solution being obtained by causing water to move to a draw solution having a cloud point from a water-containing solution containing water as a solvent via a semipermeable membrane to dilute the draw solution, and configured to discharge the water-containing solution as a concentrated water-containing solution that is concentrated;
a heater configured to heat the diluted draw solution to a temperature equal to or higher than the cloud point;
a water separator configured to separate the diluted draw solution heated by the heater into a water-rich solution and the draw solution having water content lower than that of the water-rich solution;
a cooler configured to cool a liquid and allow the liquid to flow out as a coolant;
an inflow side heat exchanger configured to perform heat exchange between the coolant flowed out from the cooler and the draw solution flowed out from the water separator; and
an outflow side heat exchanger configured to perform heat exchange between the diluted draw solution flowed out from the forward osmosis device and the water-rich solution flowed out from the water separator,
the method comprising:
supplying the draw solution stored in the water separator to the heater to be heated to a temperature equal to or higher than the cloud point through a circulation flow passage that causes a downstream side of the water separator and an upstream side of the forward osmosis device along a flowing direction of the draw solution to communicate with an upstream side of the heater and a downstream side of the forward osmosis device along a flowing direction of the diluted draw solution.

23. The method of starting the water treatment apparatus according to claim 22, wherein
the water treatment apparatus further comprises a diluted draw storage configured to store the diluted draw solution flowed out from the forward osmosis device, and an upstream side bypass flow passage configured to cause the diluted draw storage to communicate with a downstream side of the water separator and an upstream side of the forward osmosis device along a flowing direction of the draw solution, and
the method further comprises supplying the draw solution stored in the water separator to the diluted draw storage through the upstream side bypass flow passage.

24. The method of starting the water treatment apparatus according to claim 22, wherein
the water treatment apparatus further comprises a diluted draw storage configured to store the diluted draw solution flowed out from the forward osmosis device, and a downstream side bypass flow passage configured to cause the diluted draw storage to communicate with a downstream side of the water separator along a flowing direction of the water-rich solution, and
the method further comprises supplying the water-rich solution flowed out from the water separator to the diluted draw storage through the downstream side bypass flow passage.

25. The method of starting the water treatment apparatus according to claim 23, further comprising performing heat exchange between the draw solution flowed out from the diluted draw storage and the water-rich solution flowed out from the water separator by the outflow side heat exchanger to raise a temperature of the draw solution flowed out from the diluted draw storage.

26. The method of starting the water treatment apparatus according to claim 25, further comprising heating the draw solution flowed out from the diluted draw storage by the heater, after performing heat exchange between the draw solution flowed out from the diluted draw storage and the water-rich solution flowed out from the water separator by the outflow side heat exchanger.

27. The method of starting the water treatment apparatus according to claim 23, wherein
the water treatment apparatus further comprises a succeeding stage heat exchanger configured to perform heat exchange between the diluted draw solution flowed out from the diluted draw storage and the draw solution flowed out from the water separator, and
the method further comprises performing heat exchange between the draw solution flowed out from the diluted draw storage and the draw solution flowed out from the water separator by the succeeding stage heat exchanger to raise a temperature of the draw solution flowed out from the diluted draw storage.

28. The method of starting the water treatment apparatus according to claim 26, wherein
the water treatment apparatus is configured to cause the diluted draw solution flowed out from the diluted draw storage to diverge to be heat-exchanged by a parallel heat exchanger in which at least two heat exchangers are arranged in parallel, and configured to cause diverged diluted draw solutions heat-exchanged by the parallel heat exchanger to converge on an upstream side of the heater, and
the method further comprises performing heat exchange between the draw solution flowed out from the diluted draw storage and the water-rich solution flowed out from the water separator by one of the at least two heat exchangers, and performing heat exchange between the draw solution flowed out from the diluted draw storage and the draw solution flowed out from the water separator by the other one of the at least two heat exchangers.

29. The method of starting the water treatment apparatus according to claim 28, further comprising heating, by the heater, converged draw solution flowed out from the diluted draw storage, after performing heat exchange between the draw solution flowed out from the diluted draw storage and the water-rich solution flowed out from the water separator by one of the at least two heat exchangers and performing heat exchange between the draw solution flowed out from the diluted draw storage and the draw solution flowed out from the water separator by the other one of the at least two heat exchangers.
